(19) United States
(12) Patent Application Publication
(10) Pub. No.: US 2007/0065018 A1
(43) Pub. Date: Mar. 22, 2007

(54) Compressing image data

(76) Inventor: Arvind Thiagarajan, Tamil Nadu (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/539,646

(22) PCT Filed: Dec. 15, 2004
(86) PCT No.: PCT/SG04/00411

§ 371 Date: Oct. 3, 2006

(30) Foreign Application Priority Data
Dec. 15, 2003 (IN) 1014/CHE/2003
Dec. 15, 2003 (IN) 1015/CHE/2003
Dec. 15, 2003 (IN) 1016/CHE/2003
Dec. 15, 2003 (IN) 1013/CHE/2003
Apr. 15, 2004 (IN) 339/CHE/2004
Apr. 15, 2004 (IN) 338/CHE/2004
Apr. 15, 2004 (IN) 335/CHE/2004
Apr. 15, 2004 (IN) 337/CH/2004

(51) Int. Cl. G06K 9/36

(52) U.S. Cl. 382/232

(57) ABSTRACT

A method for compressing image data of an image, comprising: transforming the image data into a bit plane of first and second values; comparing each image element with a previous image element and if they are equal, recording a first value into a bit plane; and if they are not equal, recording a second value into the bit plane; and encoding repeating first and second values in the bit plane into a bit plane index; wherein the compressed image is able to be decompressed using the bit plane index and the bit plane.

### TECHNICAL FIELD

The present invention relates to a method and system for compressing image data and other highly correlated data streams. The present invention also relates to a method and system for decompressing compressed image data and other highly correlated data streams.

### BACKGROUND OF THE INVENTION

Image and data compression is of vital importance and has great significance in many practical applications. To choose between lossy compression and lossless compression depends primarily on the application.

Some applications require a perfectly lossless compression scheme so as to achieve zero errors in the automated analysis. This is particularly relevant when an automatic analysis is performed on the image or data. Generally, Huffman coding, arithmetic coding and other source coding techniques are used to achieve lossless compression of image data.

In certain other applications, the human eye visually analyzes images. Since the human eye is insensitive to certain patterns in the images, such patterns are discarded from the original images so as to yield good compression of data. These schemes are termed as “visually lossless” compression schemes. This is not a perfectly reversible process as the decompressed image data is different from the original image data. The degree of difference depends on the quality of compression, and the compression ratio. Compression schemes based on discrete cosine transforms (DCT) and Wavelet transforms followed by lossy quantization of data are typical examples of visually lossless scheme. Such systems transform the data to the frequency domain and filter away the high frequency details to achieve compression.

As a general rule, it is desirable to achieve the maximum compression ratio with zero, or minimal, possible loss in the quality of the image. At the same time, the complexity involved in the system and the power consumed by the image compression system are important parameters when it comes to a hardware-based implementation.

Usually, image compression is carried out in two steps. The first step is to use a pre-coding technique, which is normally based on signal transformations. The second step would be to further compress the data values by standard source coding techniques such as, for example, Huffman or arithmetic coding schemes. Most efficient compression techniques require a transformation. This is also known as pre-coding. The initial pre-coding step is the most critical and important operation in image compression. The complexity involved with DCT and Wavelet based transformations is quite high because of the large number of multiplications involved. This is illustrated in the following DCT equation:

$$DCT ( i , j ) = \frac{1}{\sqrt{2 N}} C ( i ) C ( j ) {\sum }_{x = 0}^{x - 1} {\sum }_{y = 0}^{N - 1} f ( x , y ) cos ⌈ \frac{( 2 x + 1 ) i π}{2 N} ⌉ cos ⌈ \frac{( 2 y + 1 ) j π}{2 N} ⌉$$

$$where C ( x ) = \frac{1}{\sqrt{2}} if x = 0 , else 1 if x > 0$$

In addition to the large number of multiplications involved in carrying out the above DCT equation, there is also a zigzag rearrangement of the image data, which involves additional complexity. DCT transformation uses a mathematical algorithm to generate frequency representations of a block of video pixels. DCT is an invertible, discrete orthogonal transformation between time and frequency domain.

Transformation aids in increasing the efficiency of a second step, the entropy coder. At this stage, if the entropy coder produces good compression ratios, then the pre-coding should transform the data into a form suitable for the entropy coder. If the transformation is not efficient, then the entropy coder becomes redundant. Thus, pre-coding is the most important stage of any image compression algorithm.

Another important property of any transformation is that it is reversible, to allow the reverse process to be applied at the decompression stage to obtain the original image. This transformation is extensively used in JPEG algorithms and their variants.

However, DCT suffers from several problems. Firstly, the equation is complex in terms of the number of multiplications and additions. In the 2D case, with an array of dimension N×N, the number of multiplications is in the order of 2N³ using a separable approach of computing 1D row and column DCTs. Specifically, for an 8×8 pixel array which is used in the JPEG family, 1024 multiplications and 896 additions are required.

There have not been any significant improvements to reduce this computational overhead.

Even though the image data is an integer, their multiplication to cosine terms in the formula produces fractional numbers or real numbers because cosine values are fractional in nature until and unless they are integer multiples of pᵢ, which may not be the case. Since fractional numbers need infinite precision to store them exactly, they might produce errors in the reverse process, resulting in loss.

Another popular transformation is the wavelet transform. This is used, for example, in the JPEG2000 image compression standard. A mother wavelet is used to decompose the image data into frequency sub-bands, which in turn increases the redundancy in most of the sub-bands, thereby improving compression ratios. Used in their original form, the mother wavelets do not give integer-to-integer transformation but when used after a process called lifting, they become integer-to-integer transforms. This makes the entire process lossless but does not achieve a high compression ratio.

Colour transformations also offer improvements to the compression technique. A commonly used colour space is RGB. In RGB, every pixel is quantized by using a combination of Red, Green and Blue values. This format is popular among graphic designers, but is not ideal as a compression algorithm.

It is desirable to provide an image compression system which does not involve rigorous transforms, and complex calculations. It also has to be memory efficient and power efficient.

There are various image compression techniques presently available. A familiar few are JPEG, JPEG-LS, JPEG-2000, CALIC, FRACTAL and RLE.

JPEG compression is a trade-off between degree of compression, resultant image quality, and time required for compression/decompression. Blockiness results at high image compression ratios. It produces poor image quality when compressing text or images containing sharp edges or lines. Gibb's effect is the name given to this phenomenon where disturbances/ripples may be seen at the margins of objects with sharp borders. It is not suitable for 2-bit black and white images. It is not resolution independent, and does not provide for scalability, where the image is displayed optimally depending on the resolution of the viewing device.

There are various image compression techniques presently available. A familiar few are JPEG, JPEG-LS, JPEG-2000, CALIC, FRACTAL and RLE.

JPEG-LS does not provide support for scalability, error resilience or any such functionality. Blockiness still exists at higher compression ratios and it does not offer any particular support for error resilience, besides restart markers.

JPEG-2000 does not provide any truly substantial improvement in compression efficiency and is significantly more complex than JPEG, with the exception of JPEG-LS for lossless compression. The complexity involved in JPEG-2000 is higher for a lower enhancement in the compression ration and efficiency.

Although CALIC provides the best performance in lossless compression, it cannot be used for progressive image transmission as it implements a predictive-based algorithm that can work only in lossless/nearly-lossless mode. Complexity and computational cost are high.

These conventional schemes for image compression are not very well suited for hardware-based implementation.

The true requirement is an image compression system which does not involve rigorous transforms, and complex calculations. It also has to be memory efficient and power efficient.

All data compression techniques are based on the fundamental principle of Shannon's Information Theory. This theory states that there is a limit to the number of bits required to code a unique symbol, also known as entropy. This is described by the following equation:
H=−pᵢ log₂ pᵢ

Where pᵢ is the probability of occurrence of the unique symbol. The implication of this equation is that if a symbol occurs frequently, then this symbol contributes to repetition and is designated a lower priority when compared to a symbol whose frequency of occurrence is less. This forms the basis for all the entropy coding or source coding schemes. A shorter codeword is given to more probable events. For example, the more frequently the symbol occurs, the shorter its codeword is.

Image data follows a Laplacian distribution. This means that the occurrence of each symbol is equiprobable. Thus, all the symbols require almost the same number of bits which results in very low compression ratios.

To achieve high compression, the image data stream is transformed from an even probability distribution in the original image to a probability distribution that has fewer symbols with a high frequency of occurrence and the remaining symbols with a relatively low frequency. This results in a significant reduction in bits per symbol and enhances the compression ratios.

Popular entropy encoders include run length encoders, Huffman, Shannon Fano, Limpel-Ziv and arithmetic encoders. Most encoding techniques allot a minimum of at least one bit per symbol.

### SUMMARY OF THE INVENTION

In a first preferred aspect, there is provided a method for compressing image data of an image, comprising:
transforming the image data into a bit plane of first and second values;
comparing each image element with a previous image element and if they are equal, recording a first value into a bit plane; and if they are not equal, recording a second value into the bit plane; and
encoding repeating first and second values in the bit plane into a bit plane index;
wherein the compressed image is able to be decompressed using the bit plane index and the bit plane.

The method may further comprise the initial step of:
comparing each image element with a previous image element and if they are within a predetermined range of each other, modifying the image element to be equal to the previous image element;
where repetition is increased to enable lossy compression of the image.

The comparison of the image elements may be performed in raster order, from left to right and then top to bottom.

The transformation may be a repetition coded compression (RCC) horizontal transformation, repetition coded compression (RCC) vertical transformation, repetition coded compression predict (RCCP) transformation, repetition coded compression adaptive (RCCA) transformation or a repetition coded compression (RCC) multidimensional transformation.

Each image element may be a pixel.

The first value may be a 1, and the second value may be a 0.

For the repetition coded compression horizontal transformation, repetition coded compression vertical transformation, repetition coded compression predict transformation, a single bit plane may be used to store the values.

For the repetition coded compression multidimensional transformation, comparison may be in both horizontal and vertical directions, and a separate bit plane may be used for each direction.

The bit-planes for the horizontal and vertical directions may be combined by binary addition to form a repetition coded compression bit-plane.

The combining may be by binary addition, only the second values being stored for lossless reconstruction of the image.

The result of the combining may be repetition coded compression data values, all other image data values may be able to be reconstructed using the repetition coded compression data values, and the bit planes for the horizontal and vertical directions.

Storage in bit planes may be in a matrix.

A single mathematical operation may be performed for each image element.

For the repetition coded compression predict transformation, a mapping value may be used to replace repeating image elements.

The mapping value may be a value that does not exist in the bit plane.

The mapping value may be a value that exists in the bit plane. If the image element is equal to the previous image element and not equal to the mapping value, the image element may be replaced with the mapping value. If the image element is equal to the mapping value and equal to the previous image element, the image element may not be replaced. If image element is equal to the mapping value and not equal to the previous image element, the image element may be replaced with the previous image element.

In a second aspect, there is provided a system for compressing image data of an image, comprising:
a data transforming module to transform the image data into a bit plane of first and second values by comparing each image element with a previous image element and if they are equal, recording a first value into the bit plane; and if they are not equal, recording a second value into the bit plane;
a data rearranging module to rearrange the transformed image data by causing elements of the image data to be repetitive; and
an encoder to encode repeating first and second values in the bit plane into a bit plane index;
wherein the compressed image is able to be decompressed using the bit plane index and the bit plane.

The number of elements repeated may be dependant upon a predetermined level of image quality selected for the compressed image. The predetermined level of image quality may be user defined.

The system may further comprise a source coder to receive the rearranged data as input. The source coder may comprise an arithmetic coder preceded by a run length encoder.

The system may further comprise:
a camera for capturing at least one image and for supplying digital data to the data transforming module;
a reshaping block for rearranging the digital data into a matrix of image data values;
a processor for receiving the matrix of image data values and compressing the image data values to form compressed data; and
a memory for storing the compressed data.

The camera may be analog, and the system may further comprise an analog-to-digital converter to convert the analog image into digital data.

In a third aspect, there is provided a method for decompressing compressed data, comprising:
run-length decoding the compressed data;
arithmetically decoding the compressed data;
reverse transforming the decoded data; and
rearranging the transformed decoded data into a lossless decompressed form.

The reverse transformation may be one dimensional including a horizontal variant, a vertical variant, or a predict variant. The reverse transformation may be two dimensional such as a multidimensional variant.

The rearrangement of the transformed decoded data may comprise a reversible sort process and a last to first rearrangement.

The compressed data may be image data. The image data may originate from a photo, drawing or video frame.

In a fourth aspect, there is provided a system for decompressing compressed data, comprising:
a run-length decoder and an arithmetic decoder for decoding the compressed data;
a reverse transforming module to reverse transform the decoded data; and
a data rearranging module to rearrange the transformed decoded data into a lossless decompressed form.

The reverse transformation may be one dimensional including a horizontal variant, a vertical variant, or a predict variant. The reverse transformation may be two dimensional such as a multidimensional variant.

The rearrangement of the transformed decoded data may comprise a reversible sort process and a last to first rearrangement

The compressed data may be image data. The image data may originate from a photo, drawing or video frame.

A portion of the image data may be compressed lossless while the remaining portion of the image data is compressed lossy.

Rearranged data may be passed to an input of a source coder. The source coder may comprise an arithmetic coder preceded by a run length encoder.

The system according may further comprise additional compression of the rearranged image data wherein each element is compared with a previous element and:
(a) if they are equal, a first value is recorded; and
(b) if they are not equal, a second value is recorded.

Each element may be a pixel.

The first value may be a 1, and the second value may be a 0.

The first and second values may be stored in a bit plane. For a one-dimensional compression, a single bit plane may be used to store the values. For a two-dimensional compression, comparison may be in both horizontal and vertical directions, a separate bit plane being used for each direction.

The bit-planes for the horizontal and vertical directions may be combined by binary addition to form a repetition coded compression bit-plane. The combining may be by binary addition, only the second values being stored for lossless reconstruction of the image.

The result of the combining may be repetition coded compression data values, all other image data values being able to be reconstructed using the repetition coded compression data values, and the bit planes for the horizontal and vertical directions.

Storage in bit planes may be in a matrix.

A single mathematical operation may be performed for each element.

The method and system may be used for an application selected from the group consisting of: medical image archiving, medical image transmission, database system, information technology, entertainment, communications applications, and wireless application, satellite imaging, remote sensing, and military applications.

### BRIEF DESCRIPTION OF THE DRAWINGS

In order that the invention may be fully understood and readily put into practical effect, there shall now be described by way of non-limitative example only a preferred embodiment of the present invention, the description being with reference to the accompanying illustrative drawings in which:

FIG. 1 illustrates the entire image compression system based on repetition coded compression on a hardware implementation;

FIG. 2 is a sample grayscale image of a human brain, which is captured by magnetic resonance imaging (“MRI”) to demonstrate the compression able to be achieved by repetition coded compression system;

FIG. 3 is an enlarged image of a small region from FIG. 2;

FIG. 4 shows that the image of FIG. 2 is made up of many pixels in grayscale;

FIG. 5 shows a 36-pixel region within the sample MRI image of FIG. 2;

FIG. 6 shows the ASCII value equivalent of the image data values for the image of FIG. 2;

FIG. 7 shows the application of repetition coded compression along the horizontal direction in the image matrix;

FIG. 8 shows the application of repetition coded compression along the vertical direction in the image matrix;

FIG. 9 shows the combination of horizontal and vertical bit-planes by a binary addition operation;

FIG. 10 shows the total memory required for the 36-pixel region before and after applying repetition coded compression;

FIG. 11 shows the application of repetition coded compression to the entire image;

FIG. 12 shows the operational flow for the implementation of repetition coded compression;

FIG. 13 is a process flow diagram of the optimisation process for compressing image data;

FIG. 14 is a block diagram of a system for optimising compression of image data;

FIG. 15 is an example of an image to compress using RCC;

FIG. 16 is a graph of an even distribution of the R component of the image of FIG. 15;

FIG. 17 is a graph of the R component of the image of FIG. 15 after RCC compression which shows non-uniform distribution;

FIG. 18 is a graph of the G component of the image of FIG. 15;

FIG. 19 is a graph of the G component of the image of FIG. 15 after RCC compression;

FIG. 20 is a graph of the B component of the image of FIG. 15;

FIG. 21 is a graph of the B component of the image of FIG. 15 after RCC compression;

FIG. 22 is a process flow diagram of the RCCP encoding method;

FIG. 23 is a process flow diagram of the RCCP decoding method;

FIG. 24 is a process flow diagram of searching for an RCC value;

FIG. 25 is a process flow diagram of the RCCA encoding method; and

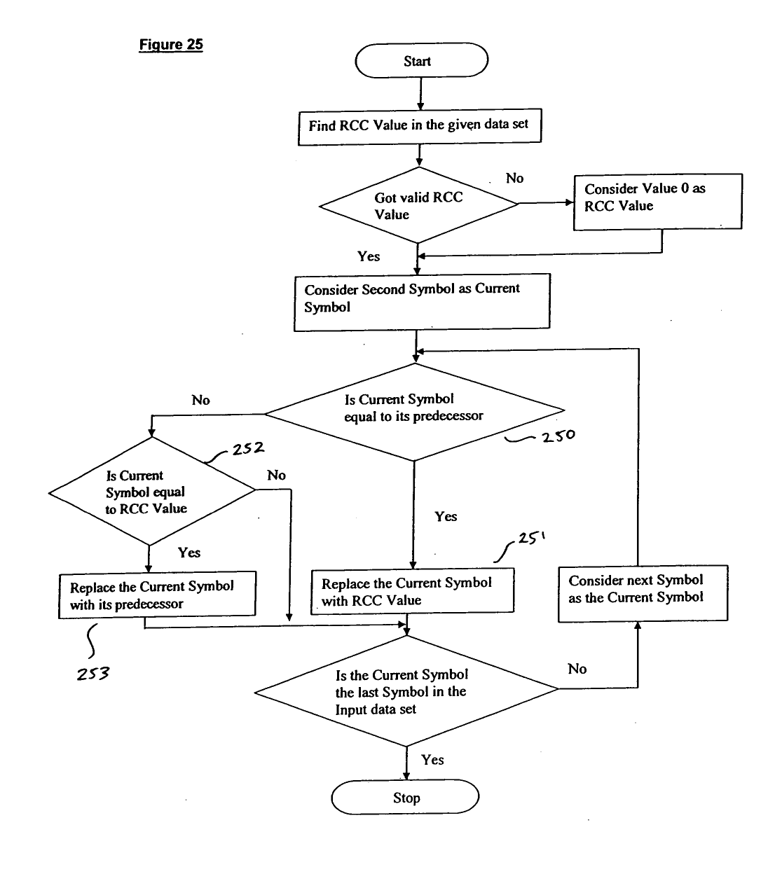

FIG. 26 is a process flow diagram of the RCCA decoding method.

### DETAILED DESCRIPTION OF PREFERRED EMBODIMENTS

Image data is highly correlated. This means that more often than not, adjacent data values in an image are repetitive in nature. Therefore, it is possible to achieve compression from this repetitive property of the image and then apply Huffman coding or other source coding schemes. High compression ratios can be achieved by combining existing data transforms and source encoders.

The human eye is more sensitive to luminance than colour. Thus, chrominance luminance and value format offers an additional compression technique. This technique uses colour transformations in image compression to generate visually lossless methods. Using lossy colour transformation provides an effect equivalent to that of quantization of other techniques in the sense that it cannot resolve the difference between small values. That is, the same integer value is used for two different integer values with a small difference. As a result of this, repetition occurs at a 24-bit level. Increasing repetition in image data provides a high compression ratio. However, one drawback to this technique is that it is not reversible perfectly, that is, it is lossy. In other words, the decompressed image data is different from the original image data. The degree of difference is dependent upon the quality of compression and also the compression ratio. The adjustment of the quality may be user-defined by setting a quality parameter such that a very highly compressed visually lossless image is produced. By visually lossless we mean that the image data is technically lossy but to the human eye the image appears lossless.

A method for indexing a bit plane is provided which is flexible as it can be applied to a wide range of image types and formats. These image types include bi-level, grayscale, 8/16/24 bit colour and medical images. The method is scalable as no change to the structure of the process is required for the various image types.

Bit plane indexing creates a redundant array of only zeros and ones. This improves the compression ratio without any loss or increase in the data set. This step is critical to obtain a high compression ratio to respond to speed.

In the bit plane indexing process, the raw original image data is decomposed to various types of bit planes. For example, these include horizontal, vertical or a combination of both, in an integer-to-integer matrix. A bit plane of zeros and ones is obtained along with the index of the image. The original image can be reconstructed perfectly losslessly with the index and the bit plane. The choice of which bit plane to use is dependent on the application or final product.

Bit plane indexing creates two arrays of codes. One array represents the index of the rearranged and sorted image. The second array is a set of zeroes and ones that form the bit plane.

Thus, the original image data is decomposed to one or more bit planes and stored along with an index of the image. The reconstruction is performed losslessly using the index and the bit plane.

In repetition coded compression (RCC), each element is compared with the previous element. If both of them are equal then a value of “1” is stored in a bit-plane. Otherwise a value of ‘0’ is stored in the bit-plane. Only the difference value is stored in a matrix, instead of storing all the repeating values.

In a one-dimensional performance of the method, only one bit-plane is used to code the repetition. RCC horizontal transformation, RCC vertical transformation and RCC predict transformation are classified as RCC in one dimension.

In a two-dimensional performance of the method, two bit-planes are used to code the repetitions in both the horizontal and the vertical directions. This is more efficient and gives a better compression ratio.

RCC Horizontal

In RCC horizontal transformation only one bit-plane is used to code the repetition of values. That is, the bit-plane is in the horizontal direction only. In the RCC horizontal transformation, adjacent data elements, for example, pixels in the case of images, are scanned in raster order (from left to right and then from top to bottom). If both adjacent data elements are equal, then a value of “1” is stored in the matrix or bit plane. Otherwise if they are not equal, a value of “0” is stored in the bit plane matrix. Only this different value is stored in the bit plane matrix instead of storing all the repeating values. Transforming the input data into a bit plane provides a greater amount of repetition than the original image data.

The RCC horizontal transformation only requires a logical mathematical comparison and no other mathematical calculation. The transformation falls within the integer-to-integer domain so as to maintain the lossless nature of the process. This process is ideal for images because a pixel is represented by 8 bits. When a logical transformation performed maps the pixel to another number, only 8 bits are required to be represented. This process preserves the lossless nature of the transform.

A horizontal variant is one dimensional by nature. Only one bit-plane is used to code the repetition of values. That is, the bit-plane is in the horizontal direction only. In the horizontal variant, adjacent data elements, for example, pixels in the case of images, are scanned in raster order (from left to right and then from top to bottom). If both adjacent data elements are equal, then a value of “1” is stored in the matrix or bit plane. Otherwise if they are not equal, a value of “0” is stored in the bit plane matrix. Only this different value is stored in the bit plane matrix instead of storing all the repeating values. Transforming the input data into a bit plane provides a greater amount of repetition than the original image data.

RCC Vertical

RCC vertical transformation is similar to the RCC horizontal transformation described except that image data is compared in a non-raster order. This transformation still preserves the lossless nature of the transform.

A vertical variant is similar to the horizontal variant transformation described except that image data is compared in a non-raster order. This transformation still preserves the lossless nature of the transform.

RCC Multidimensional

A multidimensional bit plane performs a combination of the horizontal and vertical bit planes. In some cases, it is able to achieve improved compression ratios than just using either a horizontal or vertical bit plane. Firstly, the RCC horizontal transformation is performed and stores the generated bit plane as a horizontal bit plane. Next, a RCC vertical transformation is performed and the generated bit plane is stored as a vertical bit plane. A logical “OR” is performed on the two bit planes and stored as a lossless compressed multidimensional bit plane. A “NOT” operation is performed between the multidimensional bit plane and the original image matrix. Both the “OR” and “NOT” operations maintain the integrity of the image data and still preserves the lossless nature of the transform.

Thus, the original image data is decomposed to one or more bit planes and stored along with an index of the image. The reconstruction is performed losslessly using the index and the bit plane.

The compression system is based on a mathematical comparison of adjacent image data values. The comparison is performed between adjacent image data values in both the horizontal as well as vertical directions. The bit-planes formed as a result of the comparison in the horizontal and vertical directions are respectively combined by a binary addition method. After this the resultant bit-plane positions are called as RCC bit-planes. The zero values in the RCC bit-plane are stored for lossless reconstruction of the original image. For lossless reconstruction, they are the only values stored. The stored values correspond to the same locations in the original image matrix as zeros in the RCC bit-plane and are hereinafter called RCC data values. All the other image data values can be reconstructed by using the RCC data values, and the horizontal and vertical bit-planes.

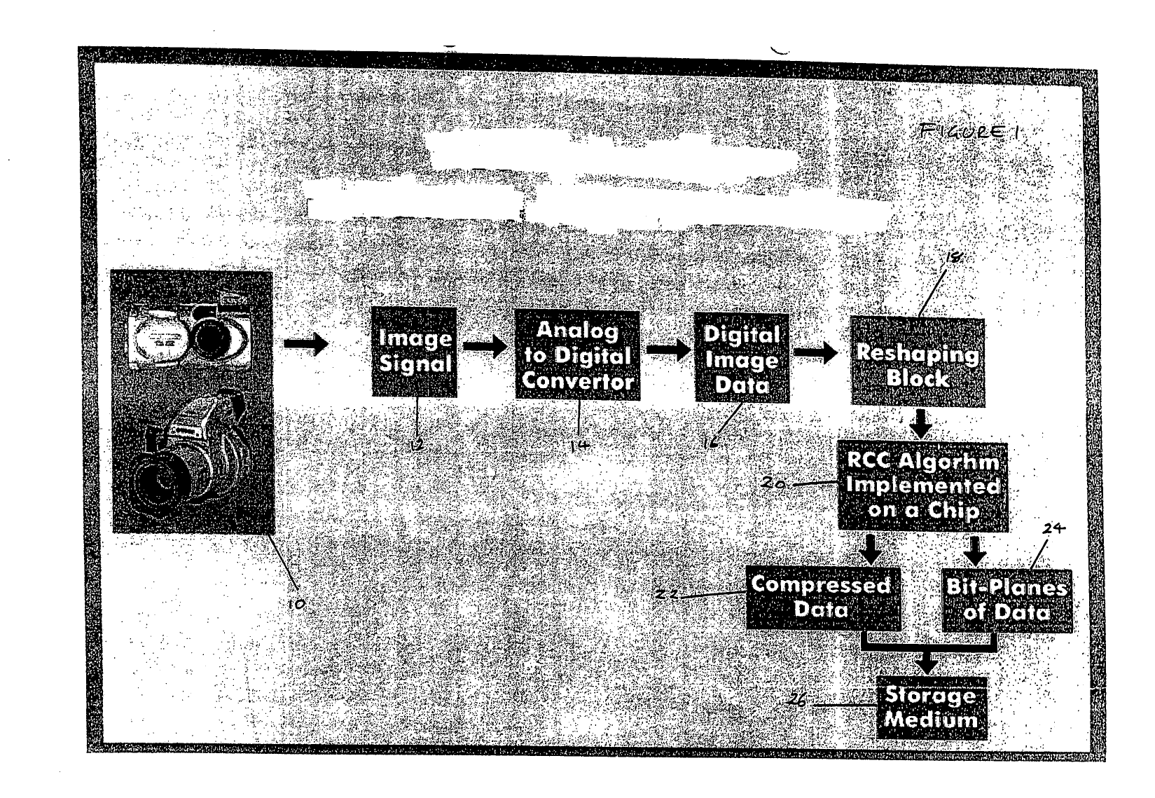

FIG. 1 illustrates the entire image compression system based on RCC for a hardware implementation. Analog image signals 12 are captured by a camera 10 and converted into corresponding digital data 16 by an analog to digital converter 14. This digital data 16 is rearranged into a matrix of image data values by a reshaping block 18. The reshaped image matrix is stored in an embedded chip 20, which performs the entire RCC process. This therefore gives the compressed RCC data values 22 and also the bit-planes of data 24 for storage, archival and future retrieval 26.

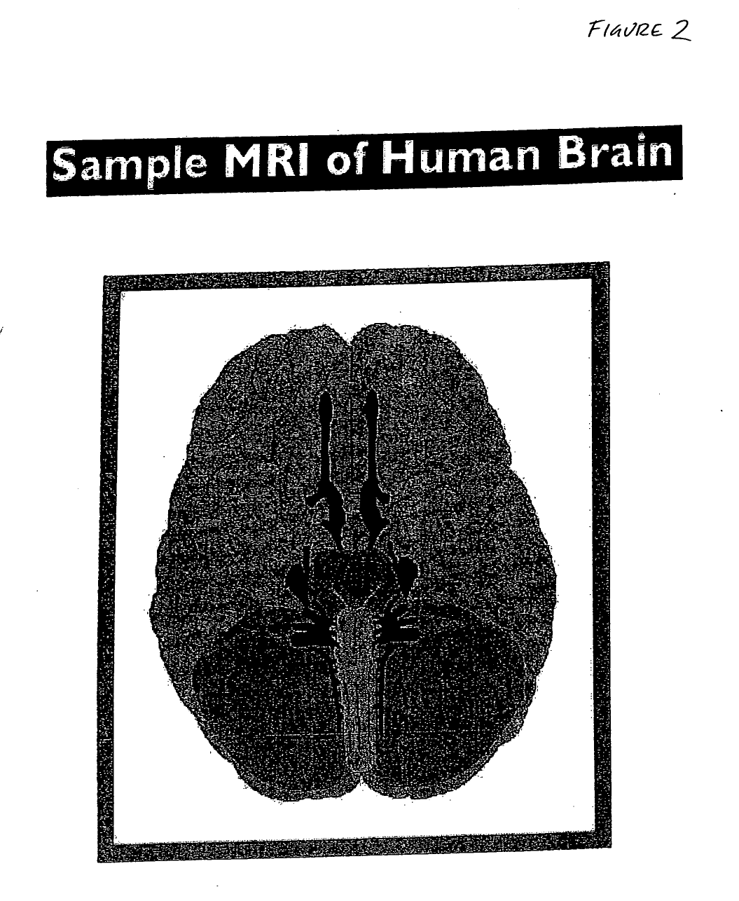

FIG. 2 is a sample image of the human brain which is captured by a magnetic resonance imaging (MRI) scan. As one example, this sample image is used to demonstrate the compression achieved by RCC. The MRI scan is a grayscale image.

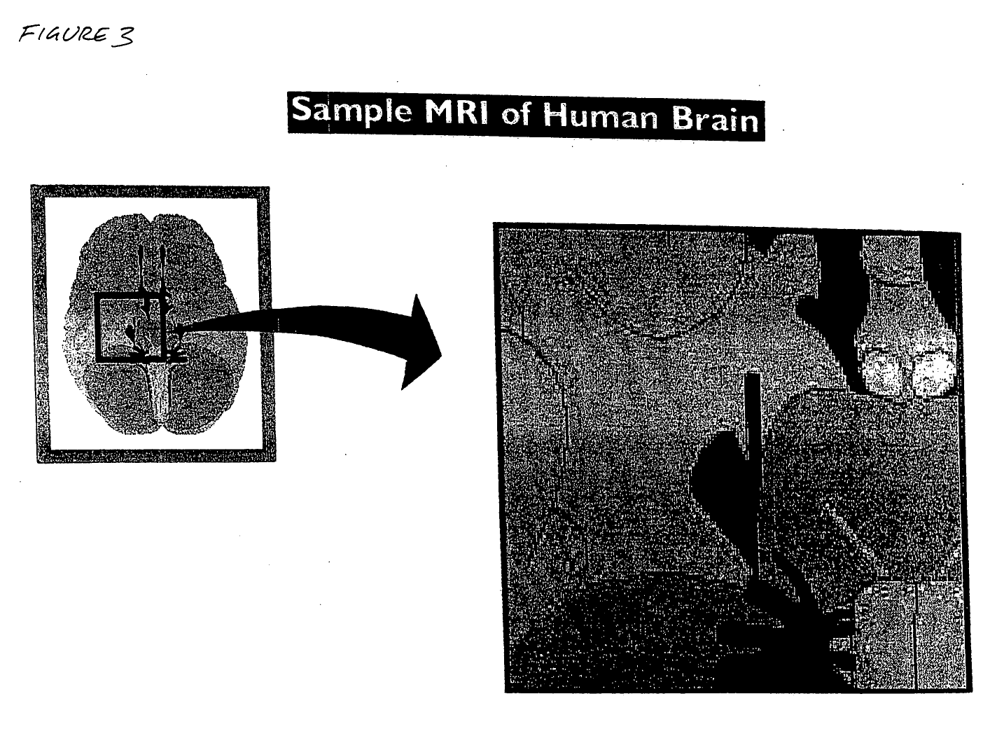

FIG. 3 zooms a small region from the sample MRI scan of the human brain. This zoomed region is also be used for demonstrating the RCC system.

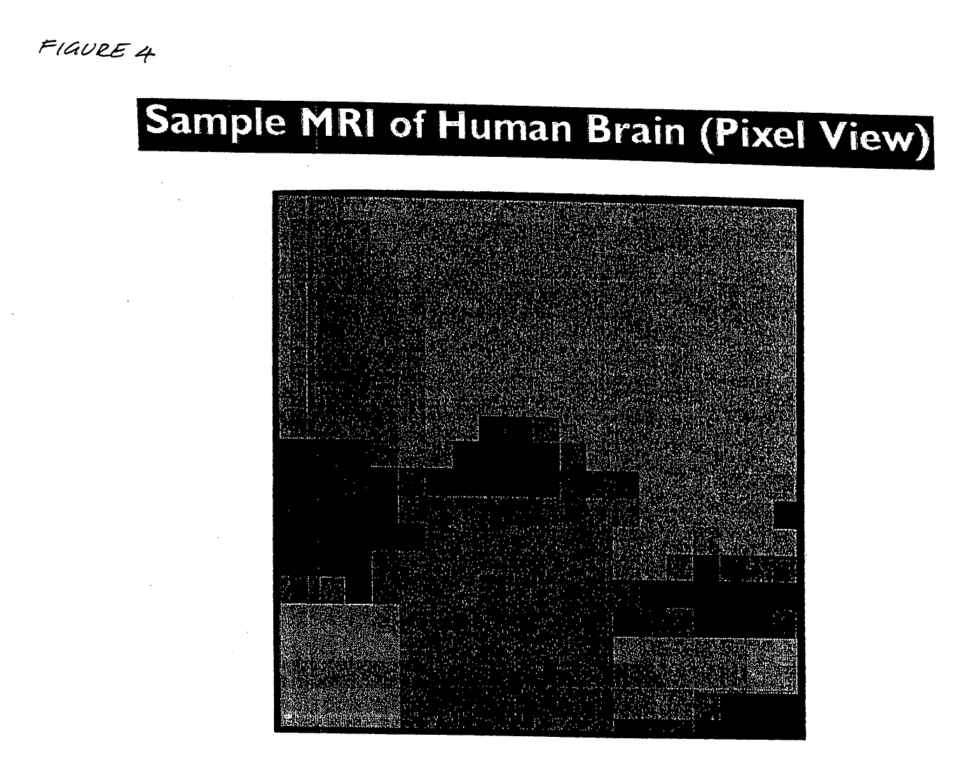

FIG. 4 shows that the image is made up of many pixels in grayscale.

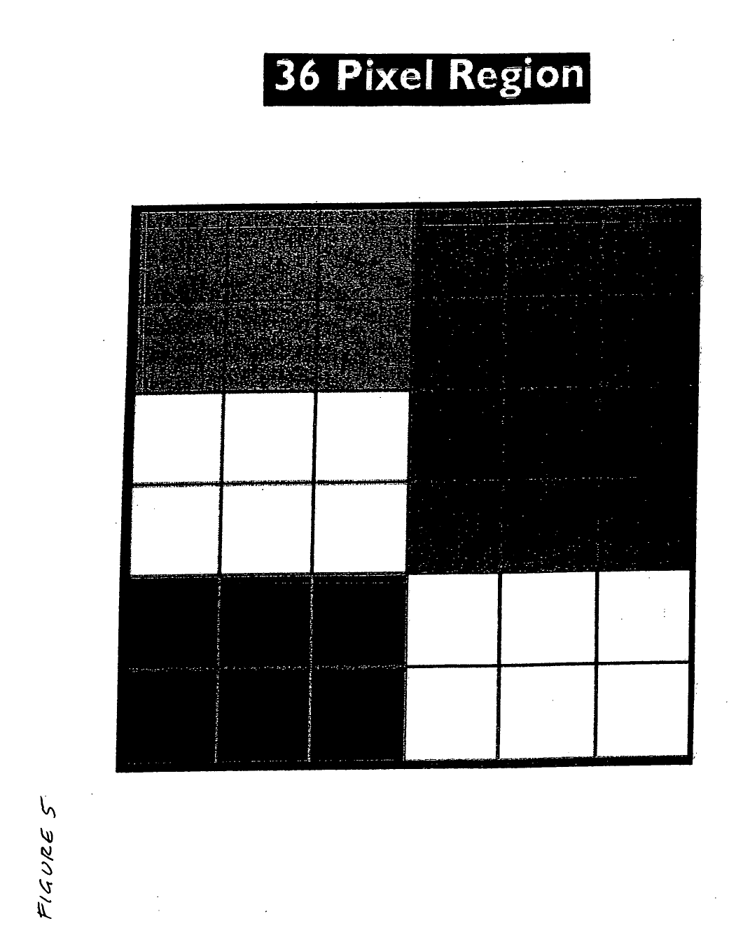

FIG. 5 shows a 36-pixel region within the sample MRI scan of the human brain.

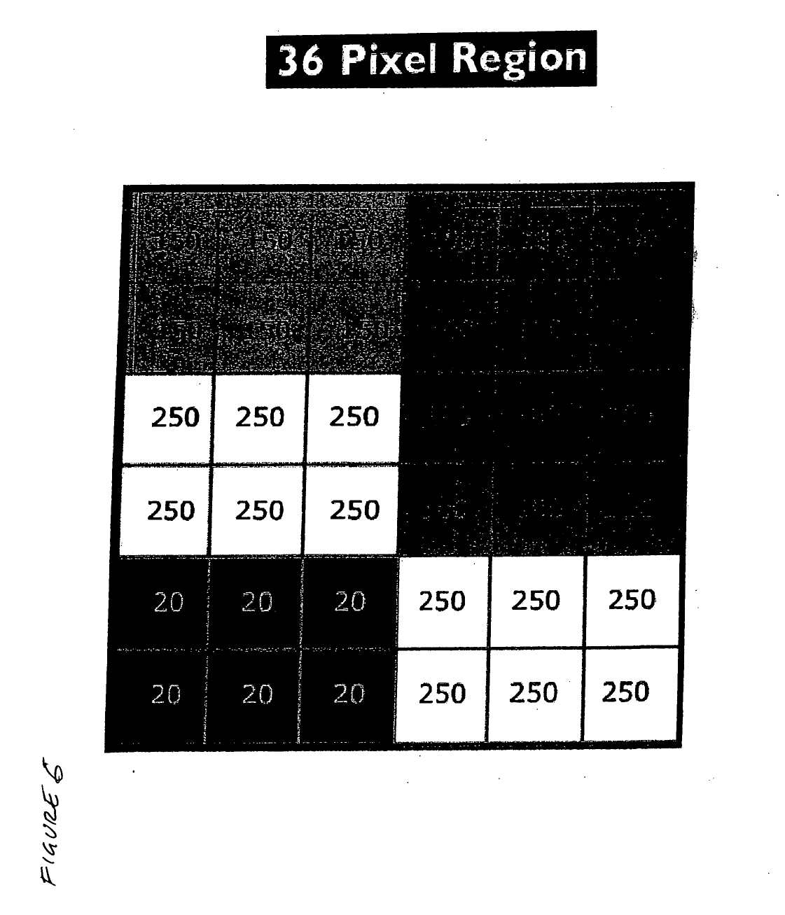

FIG. 6 shows the ASCII value equivalents of the image data values which are originally used for data storage. Each value requires eight bits (1 byte) of data memory. Currently, the 36-pixel region requires about 288 bits or 36 bytes of data memory. That data could be compressed and stored with only 112 bits after RCC.

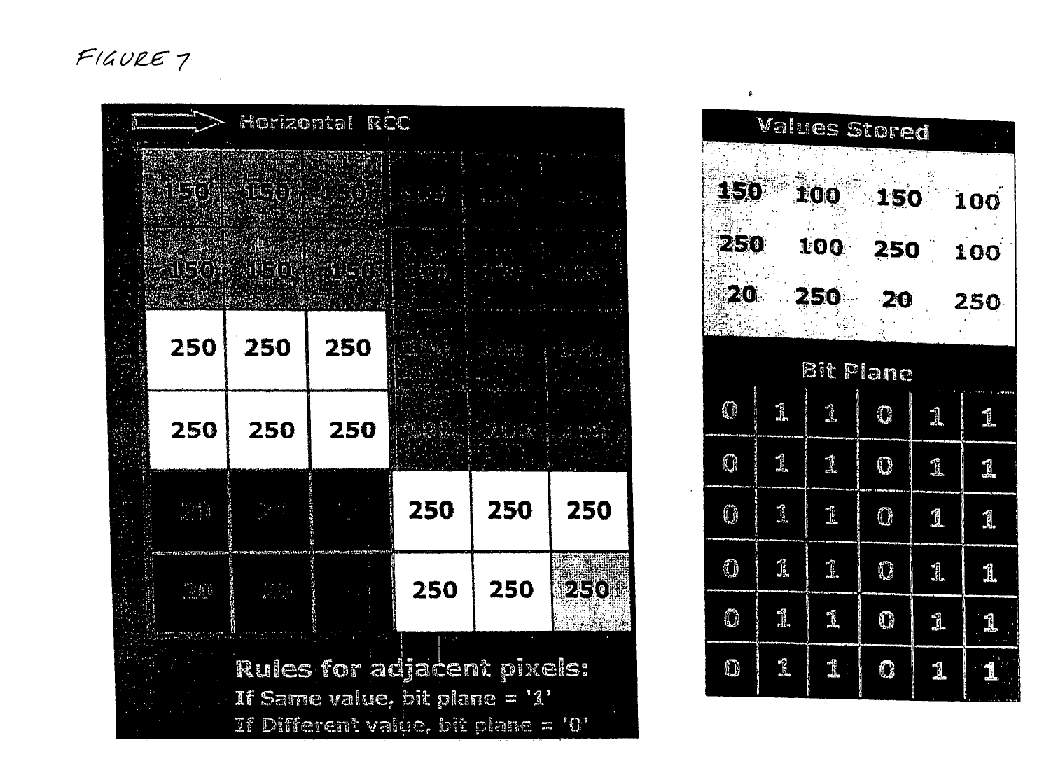

FIG. 7 shows RCC being applied along the horizontal direction in the image matrix. This results in the horizontal bit-plane and also the horizontal values stored.

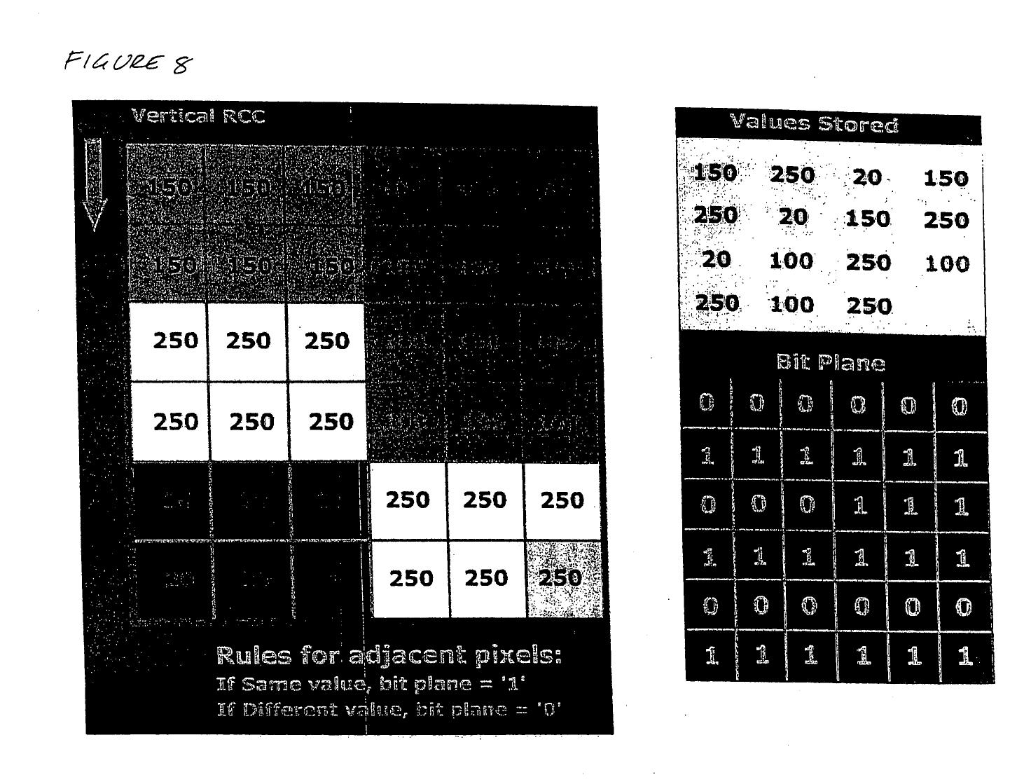

FIG. 8 shows RCC being applied along the vertical direction in the image matrix. This result in the vertical bit-plane, and also the vertical values stored.

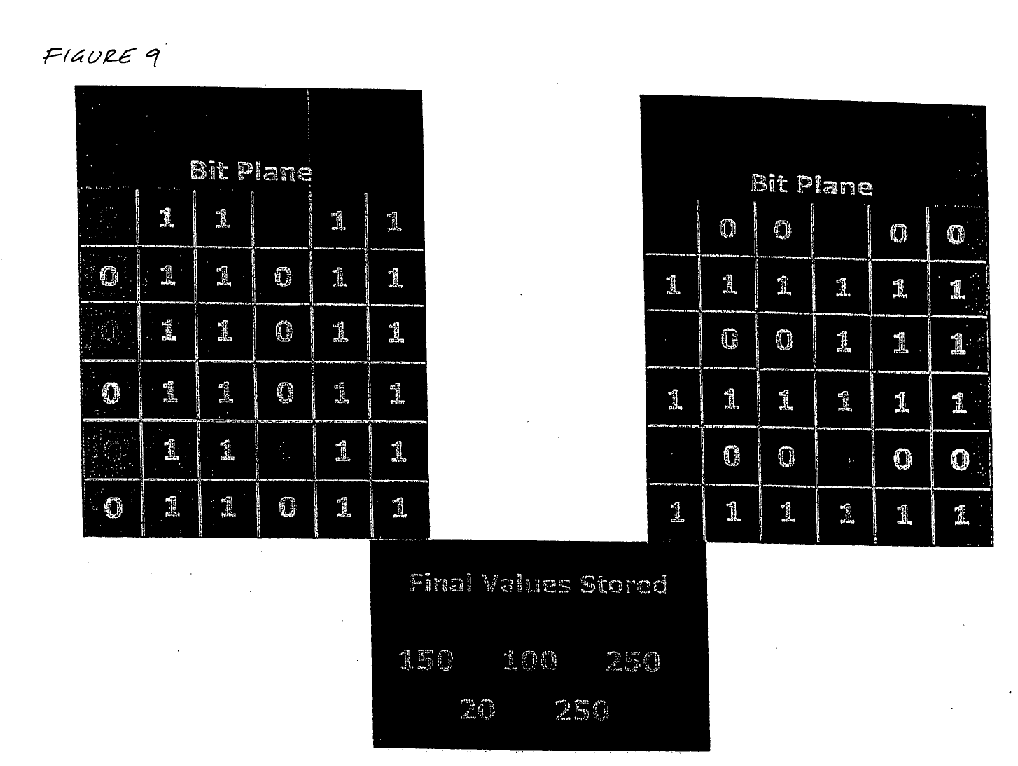

FIG. 9 shows the combination of horizontal and vertical bit-planes by a binary addition operation. This results in only five zero values which correspond to the final values stored from the original image matrix.

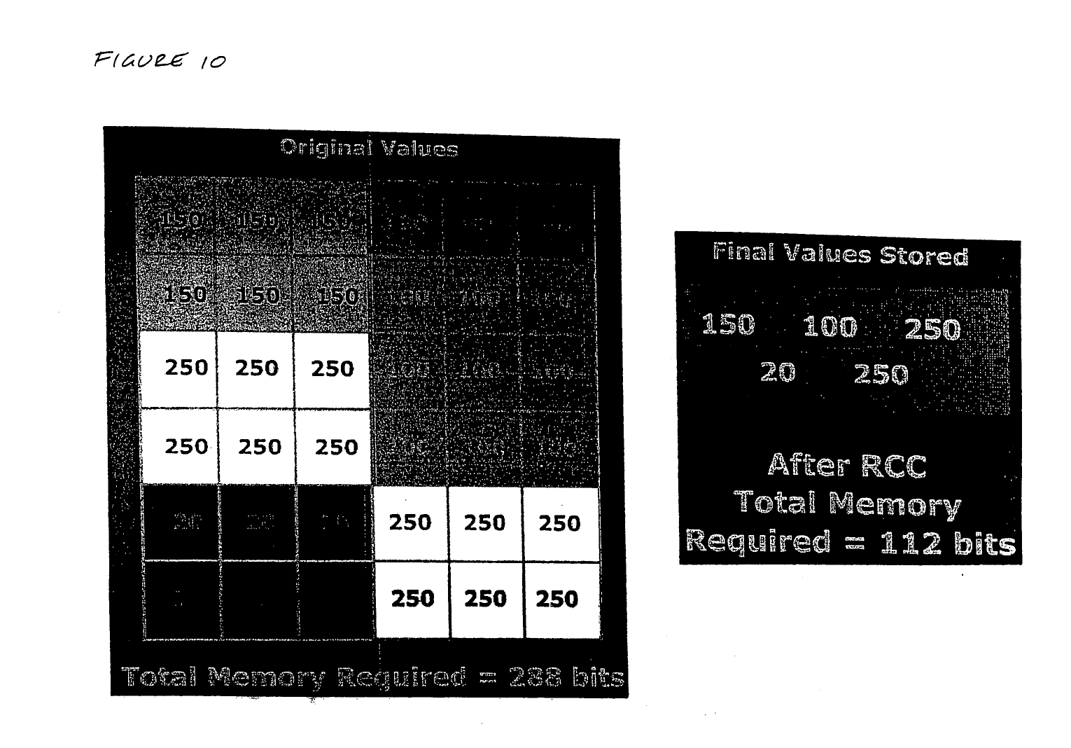

FIG. 10 shows the total memory required for the 36-pixel region before and after applying RCC. The original memory requirement was 288 bits. After applying RCC, the memory required was 112 bits. This is a significant amount of compression.

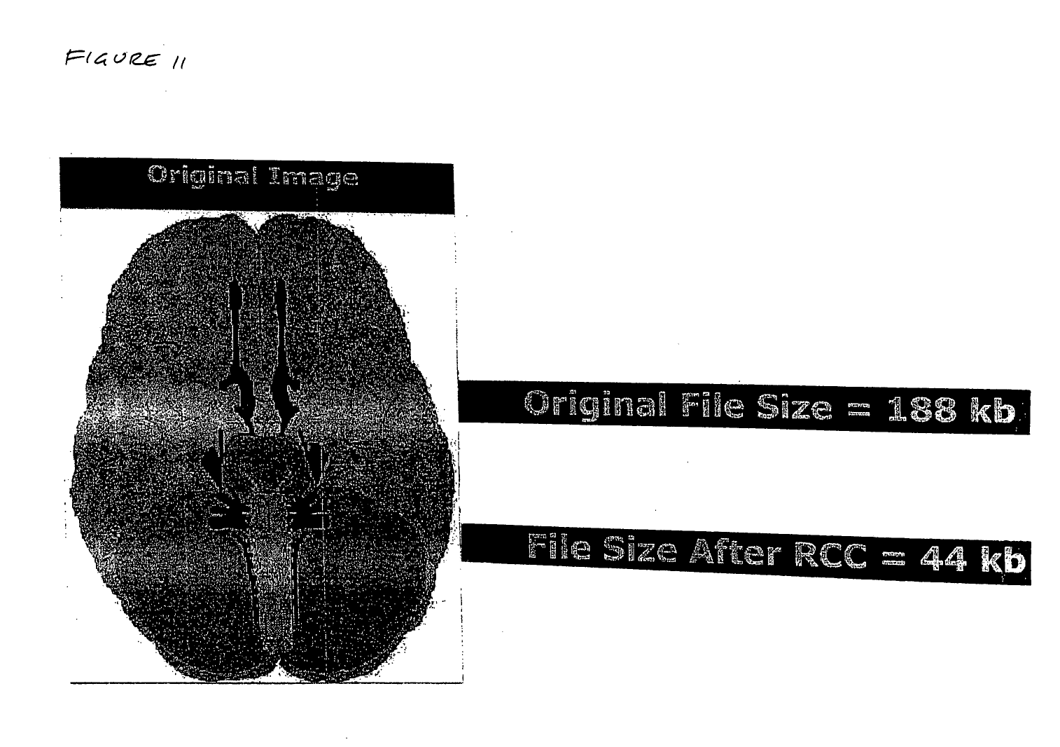

FIG. 11 shows RCC being applied to the entire image. The size is compressed to 44,000 bits from the original 188,000 bits.

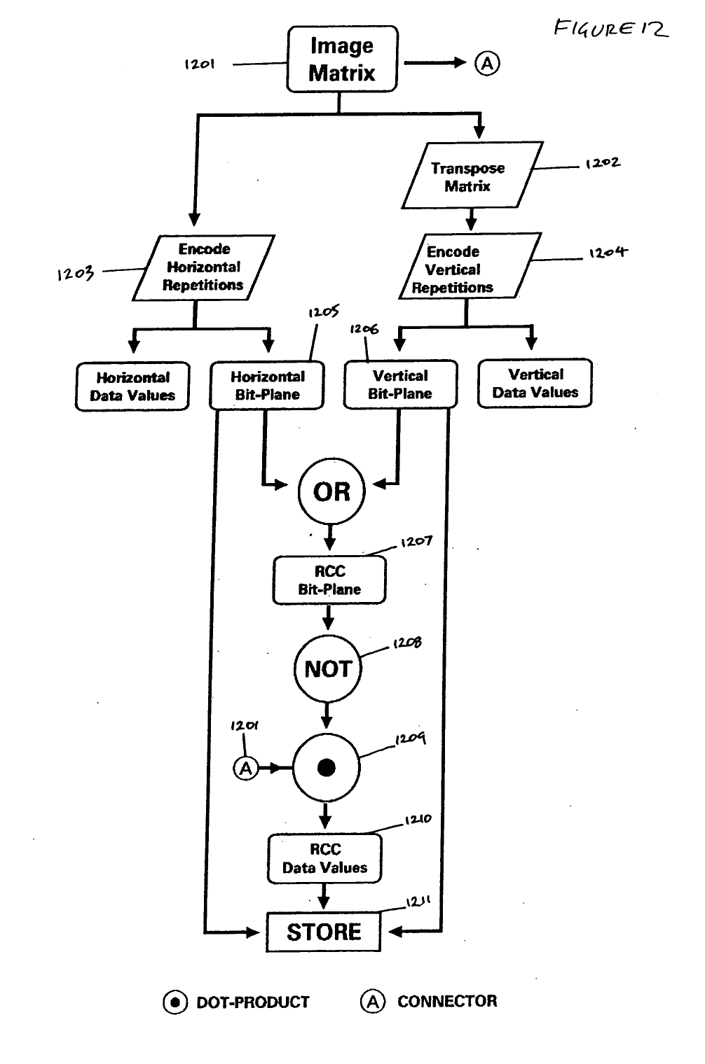

FIG. 12 shows an implementation of RCC. The image matrix 1201 is transposed 1202, encoded along the horizontal 1203 and vertical 1204 directions and the respective bit-planes 1205, 1206 are derived. Further compression is achieved by combining the horizontal and vertical bit-planes 1203, 1204 by a binary addition operation. This results in the RCC bit-plane 1207, which is logically inverted 1208 and compared 1209 with the original image matrix 1201 to obtain the final RCC data values 1210. The RCC data values 1210, together with the horizontal and vertical 1206 bit-planes are stored in a data memory 1211 for archival and future retrieval.

The encoded data can be further compressed by Huffman coding. This compression of the image data is achieved using the RCC system. This system is fast as it does not require complex transform techniques. The method may be used for any type of image file. In the example given above, the system is applied only for grayscale images. It may be applied also to colour images.

The RCC system may be applied to fields such as, for example, medical image archiving and transmission, database systems, information technology, entertainment, communications and wireless applications, satellite imaging, remote sensing, military applications.

The preferred embodiment of the present invention is based on a single mathematical operation and requires no multiplication for its implementation. This results in memory efficiency, power efficiency, and speed, in performing the compression. Because of the single mathematical operation involved, the system is reversible and lossless. This may be important for applications which demand zero loss. The compression ratios may be significantly higher than existing lossless compression schemes. RCC is a perfectly lossless data compression algorithm by which information in highly correlated data and digital images is compacted, stored and then restored to its original format without losing or changing the information. RCC is not only a visually lossless algorithm but is also pixel-to-pixel lossless giving zero mean square error.

Optimisation of Compression

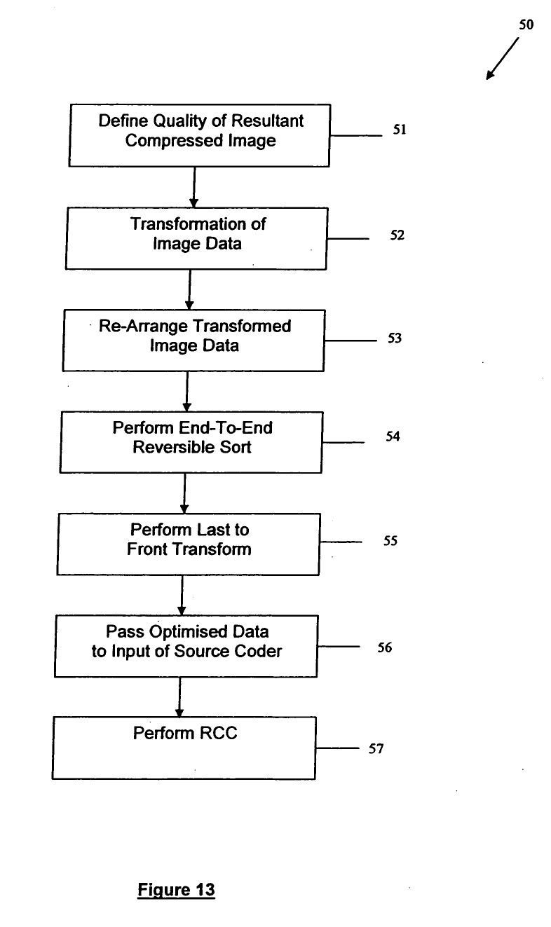

Referring to FIG. 13, a method 50 for optimising compression of image data is provided. The quality of the resultant compressed image is initially defined 51. This will determine the amount of repetition to be artificially generated in the image data. A higher amount of repetition means that a larger difference between adjacent pixels is tolerated (more lossy). If these pixels differ below a certain level they are considered to be identical. A lower amount of repetition means that the image is less lossy and visually lossless. The pre-coding block of the process is divided into two logical stages 52, 53. The first stage is transformation 52. Transformation 52 can be any one of DCT, wavelet or colour transformations. The second stage is data rearrangement 53. After the data is transformed and re-arranged, it is then directed 56 to the input of a source coder. The source coder comprises an arithmetic coder preceded by a run length encoder.

The data rearrangement stage 53 is primarily responsible for optimising the image data for compression later. This optimisation consists of an end-to-end reversible sort 54 along with a last to front transform 55. The result is that the rearranged data optimises compression by creating repetition to increase the compression ratio.

The optimisation process is scalable since the quality of the compressed image is user defined 51 at run-time. The optimisation process does not require significant changes to be made to the structure of the optimisation process. For example, when a large set of data is to be compressed into a limited amount of disk space, the choice of a compression ratio depends on the desired quality for individual images or a group of images. For Internet applications, such as streaming media and telephony applications, it is ideal for digital media developers to be able to define quality of the resultant compressed image by selecting the compression ratio.

Selected areas of an image rather than the entire image can be optimised for compression. For example, a selected region of the image can be compressed in a lossless manner, with the other regions of the image compressed in a lossy manner. This scenario is ideal for graphic artists that may want certain areas of their images to remain in perfect quality. The overhead complexity of optimising across the images is minimal, while significant gains in compression and quality are obtained.

High compression ratios are achieved while maintaining a reduced pixel-to-pixel error. The scalability of the optimisation process is maintained by exploiting the close correlation between adjacent pixels by artificially creating repetition.

Using the method, a lower Mean Square Error (MSE) is achieved compared to JPEG, JPEG2000. In JPEG, the MSE is higher due to the quantization process. Also, the method is visually lossless where the pixel-to-pixel losses are smaller in order to deliver high compression ratios.

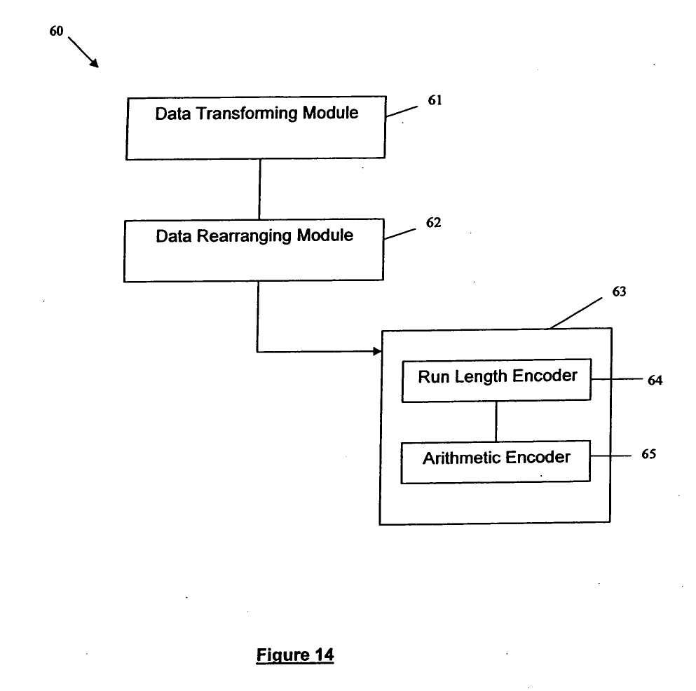

Referring to FIG. 14, optimising the compression of image data is performed by an optimisation system 60. The system 60 comprises a data transforming module 61 to transform the image data and a data rearranging module 62 to rearrange the transformed image data by artificially generating repetition of elements of the image data. The level of repetition corresponds to a predetermined level of image quality for the compressed image. The rearranged data is passed to an input of a source coder 63. The source coder 63 comprises an arithmetic coder 65 preceded by a run length encoder 64.

Additional RCC is applied 57 after the image data has been optimised for compression. In RCC, each element is compared with the previous element. If both of them are equal then a value of “1” is stored in a bit-plane. Otherwise a value of ‘0’ is stored in the bit-plane. Only the difference value is stored in a matrix, instead of storing all the repeating values.

If the application permits a lossy compression system, a modification is made to the mathematical operation so that a certain amount of loss is observed in the compression, thereby resulting in higher compression ratios. This lossy compression system would find great applications in entertainment and telecommunication systems.

In case of a lossy system of implementation, the adjacent pixels are not only compared for repetition, but also for the difference value. If the difference value between adjacent pixels is less than a given arbitrary threshold value, then the two adjacent pixels are made as the same. This further increases the number of repetitions in the image data and therefore also increases the compression ratio after applying RCC. The value of the threshold can be varied according to the requirements of the particular application, and system. The higher the threshold, the better the compression ratio and also the higher the loss in the quality of the reconstructed image.

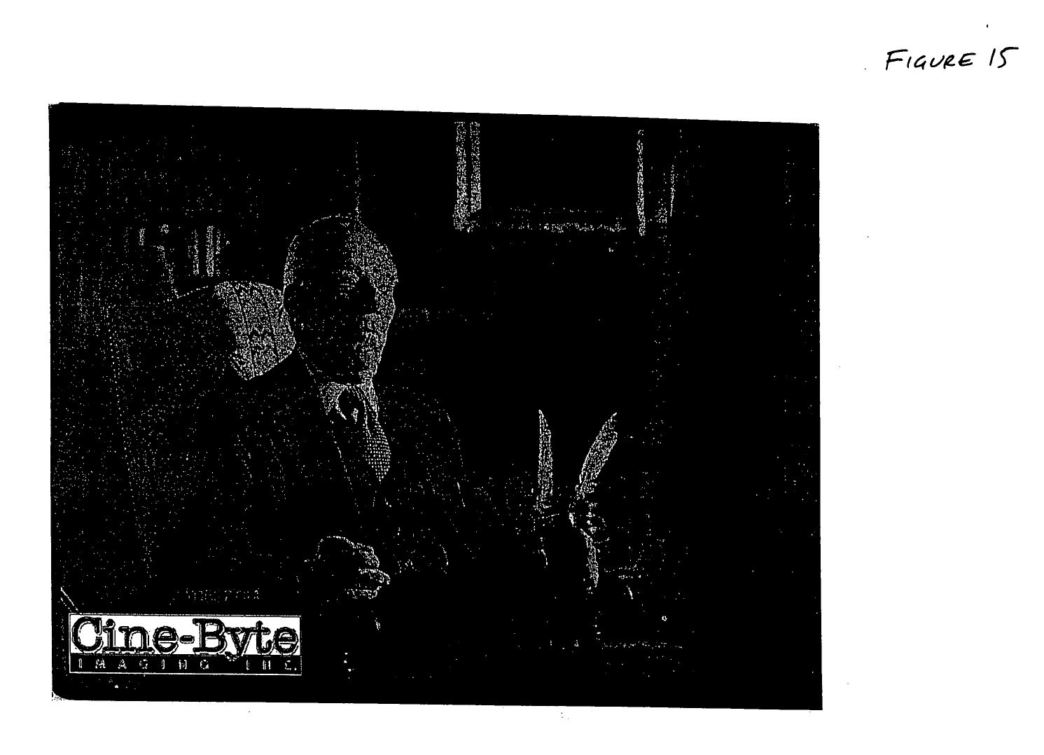

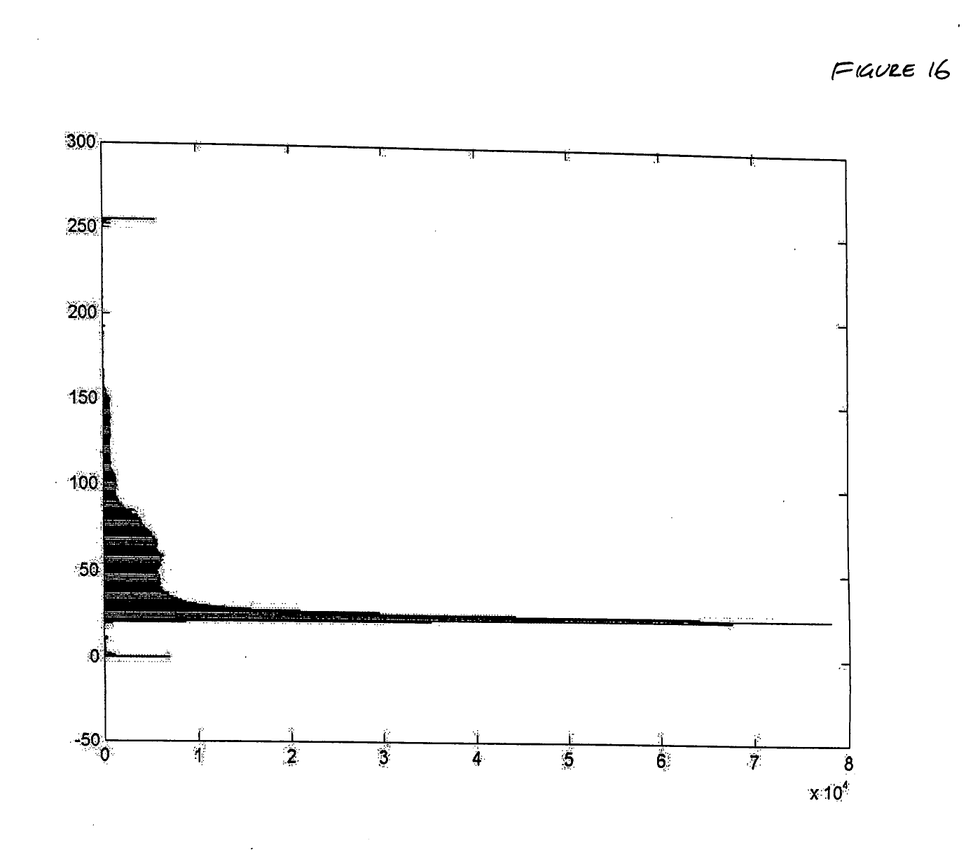

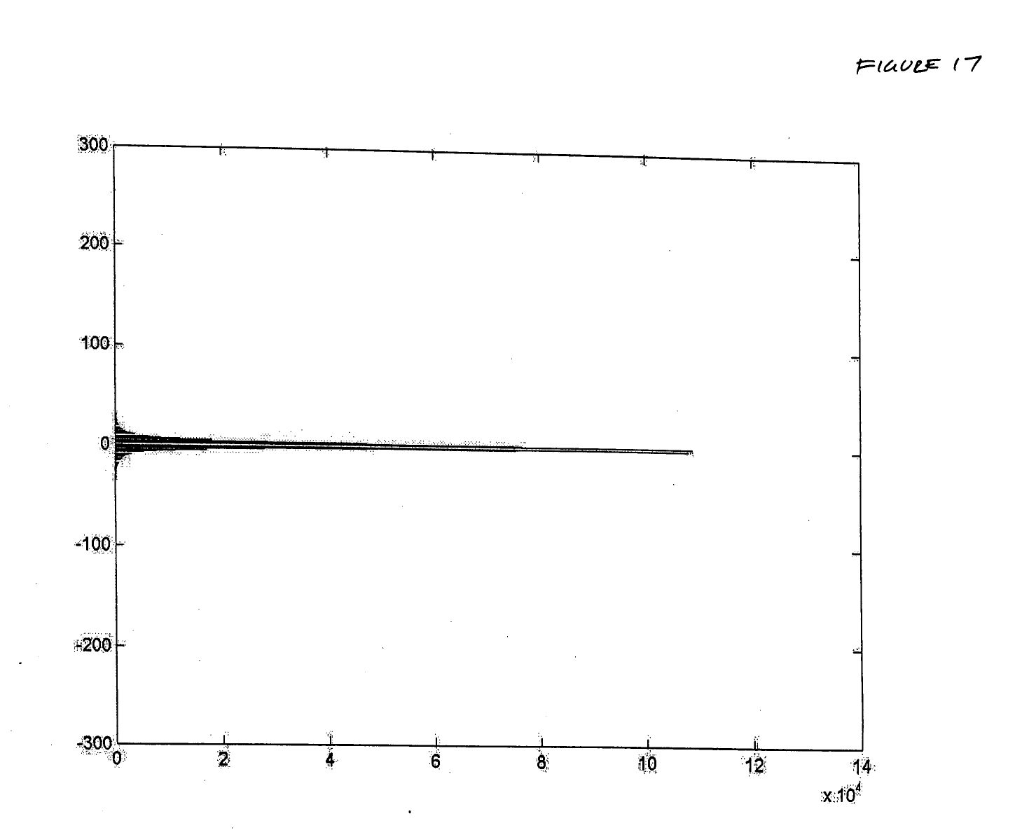

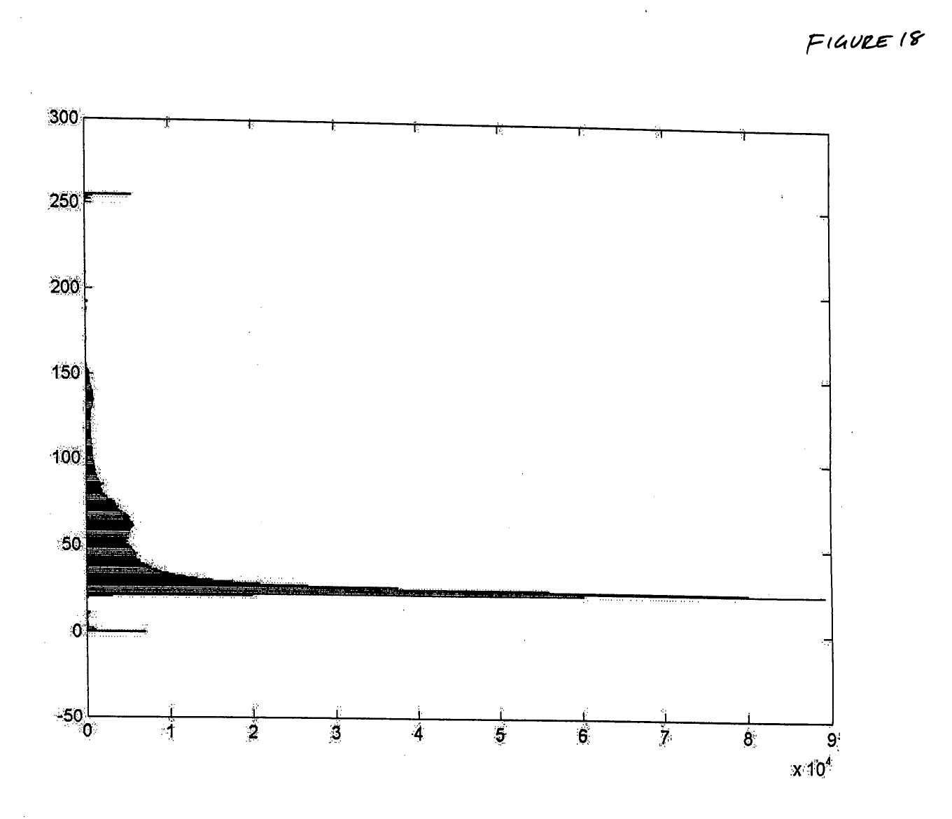

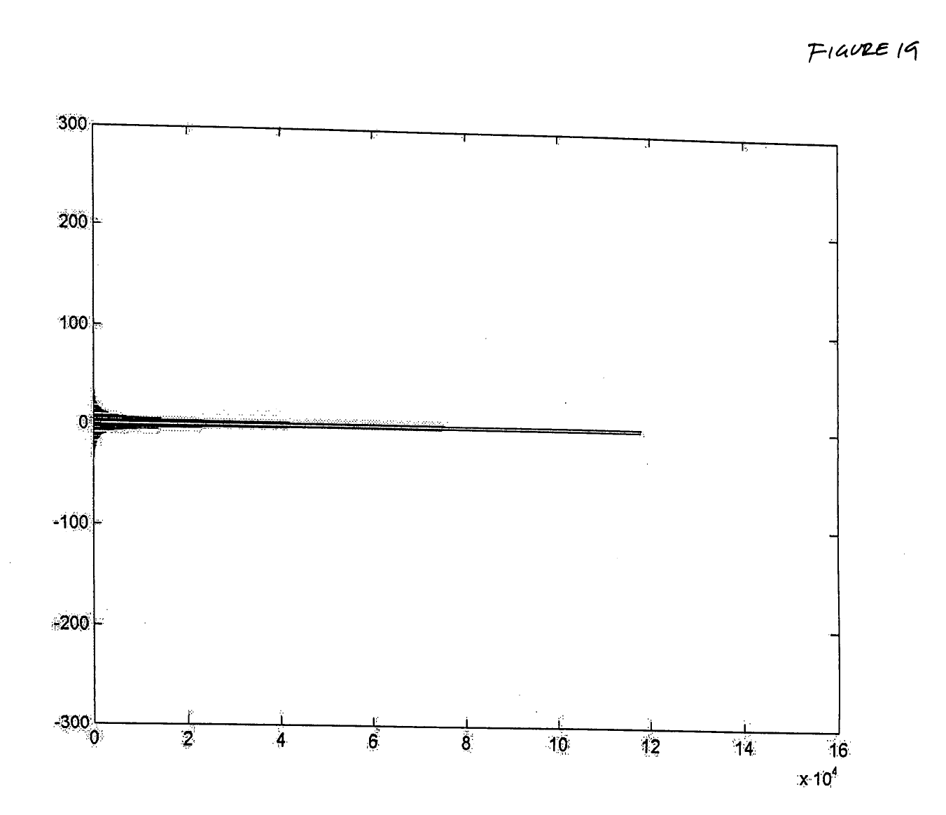

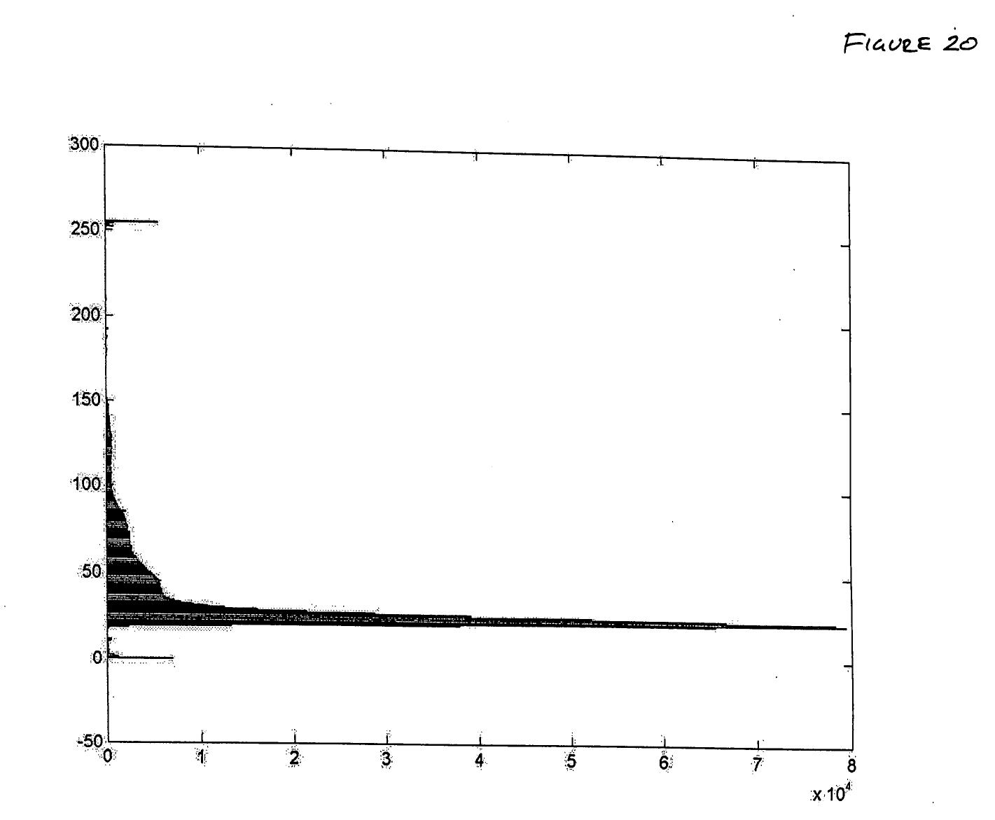

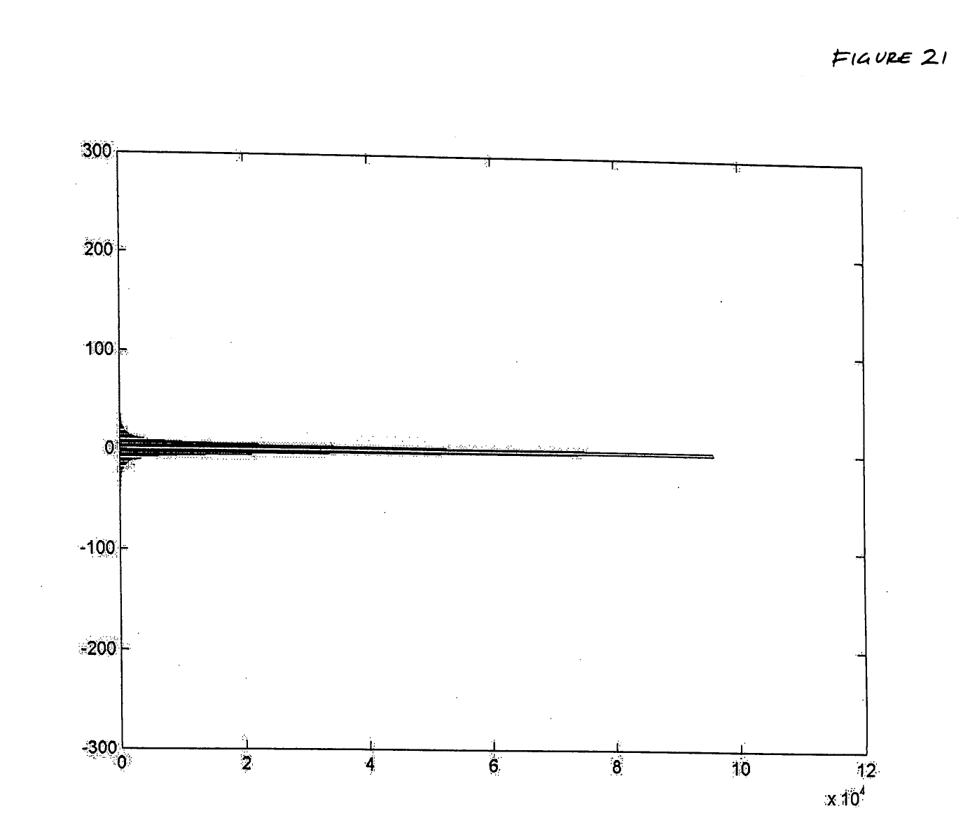

FIGS. 15 to 21 illustrate one example of RCC compression. The image in FIG. 15 is split into its Red, Green, and Blue components. The probability distribution of the occurrence of a symbol for the image is illustrated in FIGS. 16, 18 and 20. A symbol is a 8 bit data with values ranging from 0 to 255. This shows that before compression, the R, G, B components have an even distribution. However, an even distribution does not permit effective compression. Applying RCC, an uneven distribution is obtained. This is illustrated in FIGS. 17, 19 and 21. RCC compression causes the occurrence of one particular value to increase many times, and at the same time, the occurrence of other values is decreased to almost zero. This results in one group of values having a high probability of occurrence and another group of values having a negligible probability of occurrence.

Applying entropy coding principles, the values which have a high frequency of occurrence require lesser bits to be stored. Thus the distribution obtained by RCC presents an ideal scenario for compression.

RCCP Method

RCC predict transformation compares two adjacent values in raster order. If the adjacent values are the same, then the value is stored in a bit plane matrix and gives a mapping value or RCC value to the repeatedly occurring values and stores them in another data plane matrix. This method is suitable for medical images where different values repeat themselves, and these repetitions are replaced by the RCC value and the actual value is stored in the data plane matrix. This transformation only performs logical transformations to the data and still preserves the lossless nature of the transform.

In a two-dimensional performance of the method, two bit-planes are used to code the repetitions in both the horizontal and the vertical directions. This is more efficient and gives a better compression ratio. RCC multidimensional transformation is classified as RCC in two dimensions.

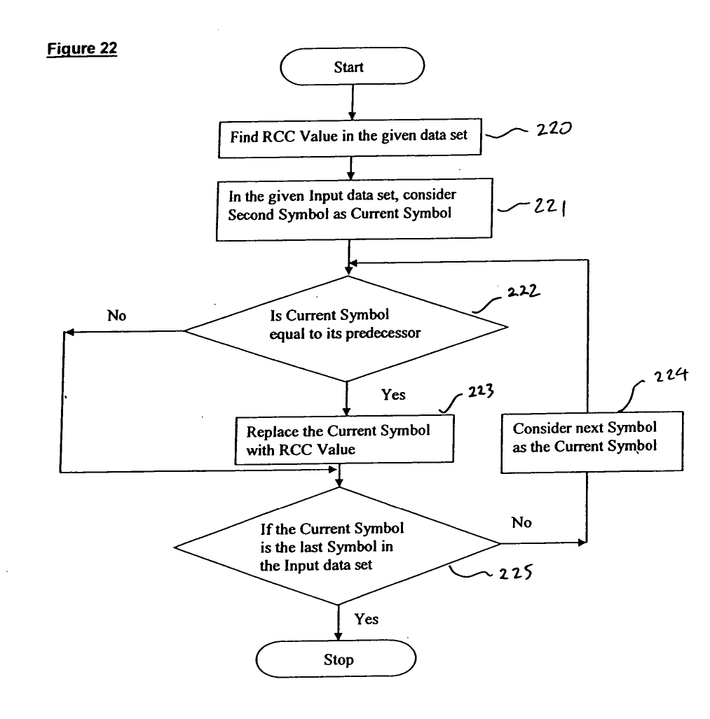

Referring to FIG. 22, the RCCP method is a fast lossless data transformation method which enhances compressibility of a given data set significantly. This is earlier described under the heading RCC predict transformation.

To perform encoding, a symbol for the RCC value must be identified and selected in the given data set 220. Any symbol that has not appeared in the given data set as RCC value is suitable. Symbols starting from 0 towards 255 are attempted to be used as the RCC value. Firstly, the symbol 0 is checked on whether it has appeared in the given data set. If 0 is not found in the data set, 0 can be used as the RCC value. Otherwise, symbol 1 is attempted and so on until a symbol is found which has not appeared in the given data set.

The RCCP method processes all the symbols in the given data set 221. In the given data set, whenever a symbol is found to be equal to its predecessor 222, then, that symbol is replaced by the RCC value 223. The RCCP method continues 224 until the last symbol in the given data set is processed 225.

RCC value: 0

| | Given Data: | | | | | | | | |
|---|---|---|---|---|---|---|---|---|---|
| | 6 | 5 | 5 | 5 | 5 | 7 | 7 | 7 | 5 |
| Position: | 0 | 1 | 2 | 3 | 4 | 5 | 6 | 7 | 8 |

In the above data set, the symbols located at positions 2, 3, 4, 6 and 7 are found to be equal to their predecessors. During encoding, these values are replaced by the RCC value, that is, symbol 0.

RCC value: 0

| | Encoded Data: | | | | | | | | |
|---|---|---|---|---|---|---|---|---|---|
| | 6 | 5 | 0 | 0 | 0 | 7 | 0 | 0 | 5 |
| Position: | 0 | 1 | 2 | 3 | 4 | 5 | 6 | 7 | 8 |

In the encoded data, the frequency of occurrence of one symbol is increased. This increase in data redundancy enhances data compression.

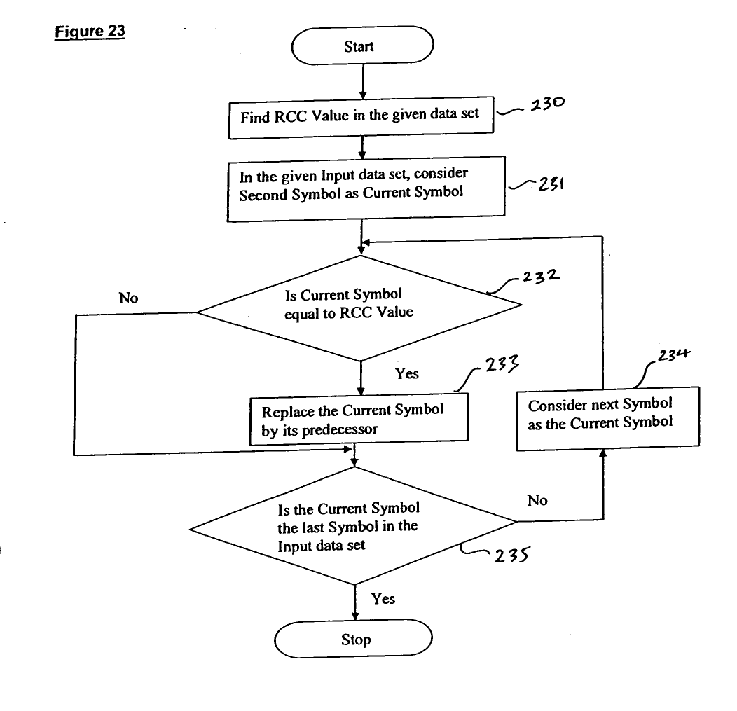

Referring to FIG. 23, to decode the encoded data, the encoded data set and the RCC value (the one that was used during encoding) are obtained 230. The RCCP method processes all the symbols in the given data set 231. During decoding, whenever the RCC value is found in the data set 232, the RCC value is replaced with its predecessor's value 233. The RCCP method continues 234 until the last symbol in the given data set is processed 235.

RCC value: 0

| | Encoded Data: | | | | | | | | |
|---|---|---|---|---|---|---|---|---|---|
| | 6 | 5 | 0 | 0 | 0 | 7 | 0 | 0 | 5 |
| Position: | 0 | 1 | 2 | 3 | 4 | 5 | 6 | 7 | 8 |

In this data set, the RCC value is found at the following positions: 2, 3, 4, 6 and 7. At the first step during this decoding process, the symbol 0 at position 2 is replaced with its predecessor, which is 5.

Now, the data set has been modified as follows:

RCC value: 0

| | Data: | | | | | | | | |
|---|---|---|---|---|---|---|---|---|---|
| | 6 | 5 | 5 | 0 | 0 | 7 | 0 | 0 | 5 |
| Position: | 0 | 1 | 2 | 3 | 4 | 5 | 6 | 7 | 8 |

Next, to decode the value at position 3, the value 5 (new value) located at position 2 is used. Now, the data set has been modified as follows:

RCC value: 0

| | Data: | | | | | | | | |
|---|---|---|---|---|---|---|---|---|---|
| | 6 | 5 | 5 | 5 | 0 | 7 | 0 | 0 | 5 |
| Position: | 0 | 1 | 2 | 3 | 4 | 5 | 6 | 7 | 8 |

Similarly, the rest of the data set is decoded. Finally, the resulting decoded data set is as follows:

RCC value: 0

| | Decoded Data: | | | | | | | | |
|---|---|---|---|---|---|---|---|---|---|
| | 6 | 5 | 5 | 5 | 5 | 7 | 7 | 7 | 5 |
| Position: | 0 | 1 | 2 | 3 | 4 | 5 | 6 | 7 | 8 |

This data set is same as the original input data set. This illustrates the RCC encoding and decoding process on a given set of data.

RCCA Method

The RCC Adaptive (RCCA) method is a variation of the RCCP method described. One limitation of the RCCP method is that it cannot be applied to a data set that has one or more appearance of all the 256 symbols. This is because in the RCCP method, a symbol that has made an appearance in the input data set cannot be considered as an RCC value. This limitation is eliminated by the RCCA method. The RCCA method makes it possible to use any symbol as the RCC value irrespective of whether it appears in the given data set.

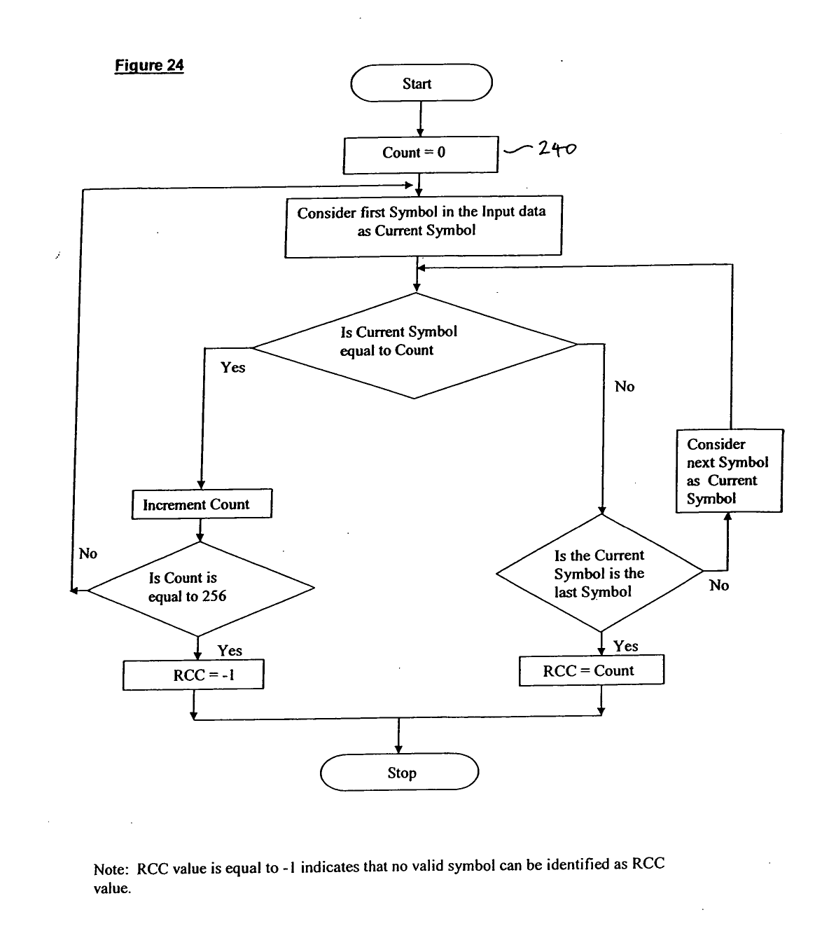

Referring to FIG. 24, initially, a symbol which has not occurred in the given data set is searched 240. If one is found, then this symbol is considered as the RCC value. If one is not found, any of the symbols can be selected as the RCC value. In most circumstances, symbol 0 is selected as the RCC value.

Referring to FIG. 5, similarly to the RCCP method, whenever a symbol is found to be equal to its predecessor 250, it is replaced by the RCC value 251. Whenever a symbol is found not equal to its predecessor, but equal to the RCC value 252, that symbol is replaced by its predecessor 253.

For example, if the symbol 0 is selected as the RCC value to encode the given set of data 9, 5, 5, 8, 0, 0, 0, 6, 0, 6.

RCC value: 0

| | Given data: | | | | | | | | | |
|---|---|---|---|---|---|---|---|---|---|---|
| | 9 | 5 | 5 | 8 | 0 | 0 | 0 | 6 | 0 | 6 |
| Position: | 1 | 2 | 3 | 4 | 5 | 6 | 7 | 8 | 9 | 10 |

The value at Position 3 is equal to its predecessor, and it is replaced with the RCC value. This produces the following data set:

RCC value: 0

| | Data: | | | | | | | | | |
|---|---|---|---|---|---|---|---|---|---|---|
| | 9 | 5 | 0 | 8 | 0 | 0 | 0 | 6 | 0 | 6 |
| Position: | 1 | 2 | 3 | 4 | 5 | 6 | 7 | 8 | 9 | 10 |

At position 5, the symbol is equal to RCC value, but, not equal to its predecessor. So, that symbol is replaced by its predecessor. The symbols at position 6 and 7 remain unchanged because they are equal to their respective predecessors. After encoding until position 7, the data set is as follows:

RCC value: 0

| | Data: | | | | | | | | | |
|---|---|---|---|---|---|---|---|---|---|---|
| | 9 | 5 | 0 | 8 | 8 | 0 | 0 | 6 | 0 | 6 |
| Position: | 1 | 2 | 3 | 4 | 5 | 6 | 7 | 8 | 9 | 10 |

The value at Position 9 is not equal to its predecessor, but equal to RCC value, so it is replaced by its predecessor. At the same time, the Symbol at Position 10 will remain unchanged because it is neither equal to its predecessor nor equal to the RCC value.

Therefore, the encoded data after RCCA has completed is as follows:

RCC value: 0

| | Encoded Data: | | | | | | | | | |
|---|---|---|---|---|---|---|---|---|---|---|
| | 9 | 5 | 0 | 8 | 8 | 0 | 0 | 6 | 6 | 6 |
| Position: | 1 | 2 | 3 | 4 | 5 | 6 | 7 | 8 | 9 | 10 |

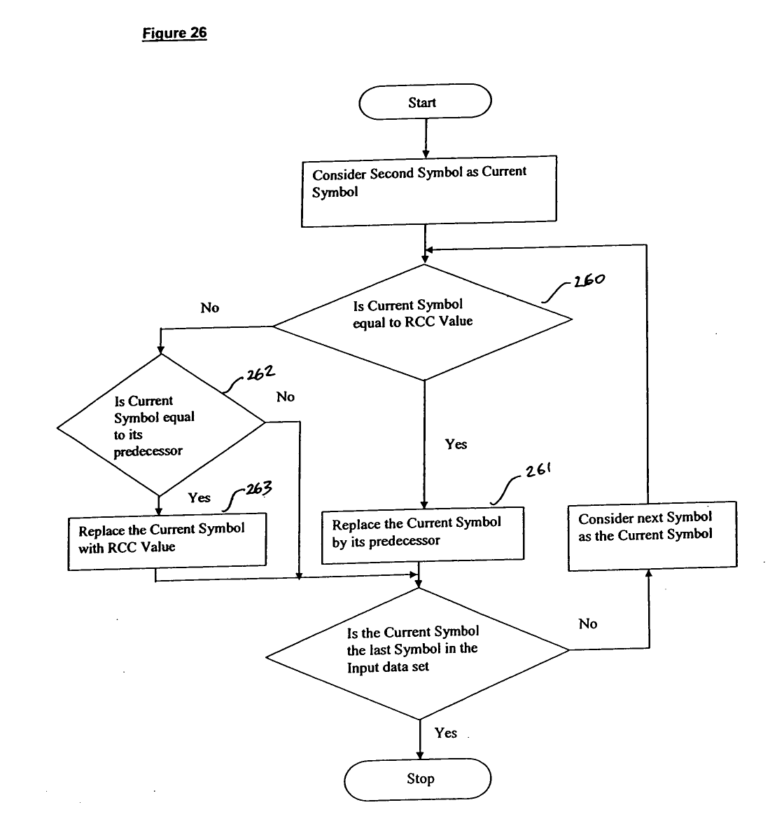

Referring to FIG. 26, to perform the decoding process, the encoded data set and the RCC value are required. During decoding, if a symbol is equal to RCC value 260, then it is replaced by its predecessor 261. If the symbol is not equal to RCC value, but equal to its predecessor 262, then it is replaced by RCC value 263. If the symbol is neither equal to the RCC value nor equal to its predecessor, then it is left unchanged.

RCC value: 0

| Encoded Data: | 9 | 5 | 0 | 8 | 8 | 0 | 0 | 6 | 6 | 6 |
|---|---|---|---|---|---|---|---|---|---|---|
| Position: | 1 | 2 | 3 | 4 | 5 | 6 | 7 | 8 | 9 | 10 |

The value at position 3 is equal to RCC value, so it is replaced by its predecessor which is 5. The resulting data set is as follows:

RCC value: 0

| Data: | 9 | 5 | 5 | 8 | 8 | 0 | 0 | 6 | 6 | 6 |
|---|---|---|---|---|---|---|---|---|---|---|
| Position: | 1 | 2 | 3 | 4 | 5 | 6 | 7 | 8 | 9 | 10 |

The value at position 4 remains unaffected because it is neither equal to RCC value nor equal to its predecessor. The value at position 5 is equal to its predecessor. So, it is replaced by the RCC value. The resulting data set is as follows:

RCC value: 0

| Data: | 9 | 5 | 5 | 8 | 0 | 0 | 0 | 6 | 6 | 6 |
|---|---|---|---|---|---|---|---|---|---|---|
| Position: | 1 | 2 | 3 | 4 | 5 | 6 | 7 | 8 | 9 | 10 |

The value at position 6 and 7 are equal to the RCC value. So, they are replaced by the predecessor of position 6 which is also equal to the RCC value. Thus, they remain unaffected. The value at position 9 is equal to its predecessor and therefore is replaced by the RCC value.

The resulting decoded data is as follows:

RCC value: 0

| Decoded Data: | 9 | 5 | 5 | 8 | 0 | 0 | 0 | 6 | 0 | 6 |
|---|---|---|---|---|---|---|---|---|---|---|
| Position: | 1 | 2 | 3 | 4 | 5 | 6 | 7 | 8 | 9 | 10 |

Thus, when the decoding process is completed, the original set of data is obtained.

Applications

RCC can be used in applications for medical imaging, digital entertainment and document management. Each of these verticals requires RCC to be implemented in a unique way to deliver a robust and powerful end product.

RCC can be deployed in the following forms for commercialisation:
1) ASIC or FPGA chips
2) DSP or embedded systems
3) Standalone hardware boxes
4) Licensable software (as DLLs or OCX)
5) Software deliverables

Although the bit-plane transformation is necessary in order for re-arrangement, other pre-processing or post-processing transformation is optional and not mandatory.

Although a specific sequence for compressing an image is described, the present invention is not limited or restricted to any particular order. In one embodiment, transformation is performed before re-arrangement. In another embodiment, transformation is performed twice, one before re-arrangement and one after re-arrangement. In a further embodiment, re-arrangement is performed twice.

Whilst there has been described in the foregoing description a preferred embodiment of the present invention, it will be understood by those skilled in the technology that many variations or modifications in details of design, constructions or operation may be made without departing from the present invention.

1. A method for compressing image data of an image, comprising:
transforming the image data into a bit plane of first and second values;
comparing each image element with a previous image element and if they are equal, recording a first value into a bit plane; and if they are not equal, recording a second value into the bit plane; and
encoding repeating first and second values in the bit plane into a bit plane index;
wherein the compressed image is able to be decompressed using the bit plane index and the bit plane.

2. The method according to claim 1, further comprising the initial step of:
comparing each image element with a previous image element and if they are within a predetermined range of each other, modifying the image element to be equal to the previous image element;
where repetition is increased to enable lossy compression of the image.

3. The method according to claim 1, wherein the comparison of the image elements is performed in raster order, from left to right and then top to bottom.

4. The method according to claim 1, wherein the transformation is a repetition coded compression horizontal transformation, repetition coded compression vertical transformation, repetition coded compression predict transformation, repetition coded compression adaptive transformation or a repetition coded compression multidimensional transformation.

5. The method according to claim 1, wherein each image element is a pixel.

6. The method according to claim 1, wherein the first value is a 1, and the second value is a 0.

7. The method according to claim 4, wherein for the repetition coded compression horizontal transformation, repetition coded compression vertical transformation, repetition coded compression predict transformation, a single bit plane is used to store the values.

8. The method according to claim 4, wherein for the repetition coded compression multidimensional transformation, comparison is in both horizontal and vertical directions, and a separate bit plane is used for each direction.

9. The method according to claim 8, wherein the bit-planes for the horizontal and vertical directions are combined by binary addition to form a repetition coded compression bit-plane.

10. The method according to claim 8, wherein the combining is by binary addition, only the second values being stored for lossless reconstruction of the image.

11. The method according to claim 9, wherein the result of the combining is repetition coded compression data values, all other image data values being able to be reconstructed using the repetition coded compression data values, and the bit planes for the horizontal and vertical directions.

12. The method according to claim 1, wherein storage in bit planes is in a matrix.

13. The method according to claim 1, wherein a single mathematical operation is performed for each image element.

14. The method according to claim 4, wherein for the repetition coded compression predict transformation, a mapping value is used to replace repeating image elements.

15. The method according to claim 14, wherein the mapping value is a value that does not exist in the bit plane.

16. The method according to claim 14, wherein the mapping value is a value that exists in the bit plane.

17. The method according to claim 16, wherein if the image element is equal to the previous image element and not equal to the mapping value, the image element is replaced with the mapping value.

18. The method according to claim 16, wherein if the image element is equal to the mapping value and equal to the previous image element, the image element is not replaced.

19. The method according to claim 16, wherein if image element is equal to the mapping value and not equal to the previous image element, the image element is replaced with the previous image element.

20. A system for compressing image data of an image, comprising:
a data transforming module to transform the image data into a bit plane of first and second values by comparing each image element with a previous image element and if they are equal, recording a first value into the bit plane; and if they are not equal, recording a second value into the bit plane;
a data rearranging module to rearrange the transformed image data by causing elements of the image data to be repetitive; and
an encoder to encode repeating first and second values in the bit plane into a bit plane index;
wherein the compressed image is able to be decompressed using the bit plane index and the bit plane.

21. The system according to claim 20, wherein the number of elements repeated is dependant upon a predetermined level of image quality selected for the compressed image.

22. The system according to claim 20, further comprising a source coder to receive the rearranged data as input.

23. The system according to claim 22, wherein the source coder comprises an arithmetic coder preceded by a run length encoder.

24. The system according to claim 20, further comprising:
a camera for capturing at least one image and for supplying digital data to the data transforming module;
a reshaping block for rearranging the digital data into a matrix of image data values;
a processor for receiving the matrix of image data values and compressing the image data values to form compressed data; and
a memory for storing the compressed data.

25. The system according to claim 24, wherein the camera is analog, and the system further comprising an analog-to-digital converter to convert the analog image into digital data.

26. A method for decompressing compressed data, comprising:
run-length decoding the compressed data;
arithmetically decoding the compressed data;
reverse transforming the decoded data; and
rearranging the transformed decoded data into a lossless decompressed form.

27. The method according to claim 26, wherein the reverse transformation is one dimensional including a horizontal variant, a vertical variant, or a predict variant.

28. The method according to claim 26, wherein the reverse transformation is two dimensional such as a multidimensional variant.

29. The method according to claim 26, wherein the rearrangement of the transformed decoded data comprises a reversible sort process and a last to first rearrangement.

30. The method according to claim 26, wherein the compressed data is image data.

31. The method according to claim 30, wherein the image data originates from a photo, drawing or video frame.

32. A system for decompressing compressed data, comprising:
a run-length decoder and an arithmetic decoder for decoding the compressed data;
a reverse transforming module to reverse transform the decoded data; and a data rearranging module to rearrange the transformed decoded data into a lossless decompressed form.

33. The system according to claim 32, wherein the reverse transformation is one dimensional including a horizontal variant, a vertical variant, or a predict variant.

34. The system according to claim 32, wherein the reverse transformation is two dimensional such as a multidimensional variant.

35. The system according to claim 32, wherein the rearrangement of the transformed decoded data comprises a reversible sort process and a last to first rearrangement.

36. The system according to claim 32, wherein the compressed data is image data.

37. The system according to claim 36, wherein the image data originates from a photo, drawing or video frame.

38. The system according to claim 32, wherein a portion of the image data is compressed lossless while the remaining portion of the image data is compressed lossy.

39. The system according to claim 32, wherein rearranged data is passed to an input of a source coder.

40. The system according to claim 39, wherein the source coder comprises an arithmetic coder preceded by a run length encoder.

41. The system according to claim 32, further comprising additional compression of the rearranged image data wherein each element is compared with a previous element and:
(c) if they are equal, a first value is recorded; and
(d) if they are not equal, a second value is recorded.

42. The system according to claim 41, wherein each element is a pixel.

43. The system according to claim 41, wherein the first value is a 1, and the second value is a 0.

44. The system according to claim 41, wherein the first and second values are stored in a bit plane.

45. The system according to claim 41, wherein for a one-dimensional compression, a single bit plane is used to store the values.

46. The system according to claim 41, wherein for a two-dimensional compression, comparison is in both horizontal and vertical directions, a separate bit plane being used for each direction.

47. The system according to claim 41, wherein the bit-planes for the horizontal and vertical directions are combined by binary addition to form a repetition coded compression bit-plane.

48. The method according to claim 47, wherein the combining is by binary addition, only the second values being stored for lossless reconstruction of the image.

49. The system according to claim 48, wherein the result of the combining is repetition coded compression data values, all other image data values being able to be reconstructed using the repetition coded compression data values, and the bit planes for the horizontal and vertical directions.

50. The system according to claim 44, wherein storage in bit planes is in a matrix.

51. The system according to claim 41, wherein a single mathematical operation is performed for each element.

52. The system according to claim 21, wherein the predetermined level of image quality is user defined.

53. The method according to claim 1, wherein the method is used for an application selected from the group consisting of: medical image archiving, medical image transmission, database system, information technology, entertainment, communications applications, and wireless application, satellite imaging, remote sensing, and military applications.
